(19) United States
(12) Patent Application Publication
(10) Pub. No.: US 2026/0239488 A1
(43) Pub. Date: Aug. 13, 2026

(54) USER EQUIPMENT AND NETWORK ENTITY

(71) Applicant: FRAUNHOFER-GESELLSCHAFT ZUR FÖRDERUNG DER ANGEWANDTEN FORSCHUNG E.V., München (DE)

(72) Inventors: Birendra GHIMIRE, Erlangen (DE); Mohammad ALAWIEH, Erlangen (DE); Thomas VON DER GRÜN, Erlangen (DE)

(21) Appl. No.: 19/468,787

(22) Filed: Feb. 3, 2026

Related U.S. Application Data
(63) Continuation of application No. PCT/EP2024/071896, filed on Aug. 1, 2024.

(30) Foreign Application Priority Data
Aug. 4, 2023 (CA) 23189862.8

(51) Int. Cl. H04W 76/28; H04W 76/27

(52) U.S. Cl. CPC H04W 76/28; H04W 76/27

(57) ABSTRACT

User equipment in wireless network, the user equipment comprising a transceiver, where the transceiver is configured to receive one or more first configurations from a network entity of the wireless network, the firstconfigurations comprising parameters for a reference signal to be transmitted by the user equipment during a particular RRC state to enable position determination; to receive a one or more second configurations from the network entity, the second configurations comprising parameters describing an active phase and an sleep phase of an UE activity cycle, wherein during the active phase the user equipment is configured to receive one or more signaling messages from a network entity, and wherein during the sleep phase, the UE is temporarily unreachable; to transmit the reference signal according to one of the one or more first configuration and/or taking into account one of the one or more second configurations.

### CROSS-REFERENCE TO RELATED APPLICATIONS

This application is a continuation of copending International Application No. PCT/EP2024/071896, filed Aug. 1, 2024, which is incorporated herein by reference in its entirety, and additionally claims priority from European Application No. 23189862.8, filed Aug. 4, 2023, which is also incorporated herein by reference in its entirety.

### TECHNICAL FIELD

Embodiments of the present invention refer to a user equipment, especially to a user equipment participating position determination, to a network entity, like a transmission-reception point (TRP) and to a network entity like a localization management function (LMFs). Further embodiments refer to corresponding methods for operating a user equipment, network entity in terms of a transmission point and network entities in terms of LMFs.

Another embodiment refers corresponding computer implemented method. In general, embodiments of the present invention are in fields of enhancing position reliability and reducing energy consumption of UEs.

### BACKGROUND OF THE INVENTION

FIG. 10 is a schematic representation of an example of a terrestrial wireless network 100 including, as is shown in FIG. 10(a), the core network 102 and one or more radio access networks RAN₁, RAN₂, . . . RAN_{N}. FIG. 10(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 10(b) shows an exemplary view of five cells, however, the RANₙ may include more or less such cells, and RANₙ may also include only one base station. FIG. 10(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 10(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 10(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 10(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 10 may be a heterogeneous network having distinct overlaid networks, e.g., a network of macro cells with each macro cell including a macro base station, like base station gNB₁ to gNB₅, and a network of small cell base stations, not shown in FIG. 10, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 10, for example in accordance with the LTE-Advanced Pro standard or the 5G or NR, new radio, standard.

In mobile communication networks, for example in a network like that described above with reference to FIG. 10, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 10. This is referred to as an “in-coverage” scenario. Another scenario is referred to as an “out-of-coverage” scenario. It is noted that “out-of-coverage” does not mean that the two UEs are not within one of the cells depicted in FIG. 10, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 11 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 10. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 12 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 12 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 11, in addition to the NR mode 1 or LTE mode 3 UEs 202, 204 also NR mode 2 or LTE mode 4 UEs 206, 208, 210 are present. In addition, FIG. 12, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 11 and FIG. 12 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

A user equipment communicating with a transmission point is configured to exchange signals like reference signals so as to perform position determination. This principle can also be used in sidelink communications, where two user equipments exchange signals, especially reference signals (PRS) based on which a measurement or position determination can be performed. The measurement can be done as follows:

A user equipment receives reference configuration and/or information based on same can output a reference signal. For example, the configuration can comprise resources to be used for the reference signal in the point of time, wherein the reference signal should be output. Another entity, like a transmission point (when establishing a communication to a transmission point like a base station) or another UE (using sidelink communication) receives the reference signal and can perform a measurement, like a run time measurement. The run time measurement enables to determine a distance between the two entities and, thus, a position determination. Often the position determination also uses measurements between the UE the position of which should be determined and further receiving entities, so as to perform triangulation. For starting and/or performing the position determination process the plurality of configuration data are exchanged. This exchange of configuration data and the exchange of the reference signals stays in contradiction to the general principle of saving energy. Therefore, there is a need for an improved approach.

It is an objective of the present invention to enable high accuracy for position determination, while increasing the energy efficiency of the network entities, especially of the user equipments.

### SUMMARY

An embodiment may have user equipment, UE, in wireless network, the user equipment comprising a transceiver, where the transceiver is configured:
to receive one or more first configurations from a network entity (e.g. TRP or LMF) of the wireless network, the one or more first configurations comprising parameters for a reference signal to be transmitted by the user equipment;
to receive a one or more second configurations from the network entity (e.g. gNB), the one or more second configuration comprising parameters describing an active phase and an sleep phase of an UE activity cycle (e.g. DRX cycle or an eDRX cycle), wherein during the active phase the user equipment is configured to receive one or more signaling messages from the network entity, and wherein during the sleep phase, the UE is temporarily unreachable (e.g. by paging);
to transmit the reference signal according to one of the one or more first configuration and taking into account one of the one or more second configurations (defining the DRX cycle).

Another embodiment may have a network entity or transmission point, TRP, or another UE comprising a transceiver configured to
to provide one or more first configurations to an user equipment, the one or more first configurations comprising parameters for a reference signal to be transmitted by the user equipment for position determination;
to provide a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging);
   so that the user equipment is enabled to transmit the reference signal according to one of the one or more first configuration and taking into account one of the one or more second configurations (defining the DRX cycle).

Another embodiment may have a network entity or transmission point, TRP, or another UE comprising a transceiver configured to communicate with a UE which is configured to transmit and/or a reference signal during an active phase of an UE activity cycle (e.g. DRX cycle or an eDRX cycle); wherein the transceiver is configured to output a one or more first configurations and one or more second configurations including a validity information or the validity information to the UE, wherein a configuration of the UE is valid for a validity area or wherein the UE is allowed to communicate in accordance to the validity information.

Another embodiment may have a network entity or LMF configured to perform a measurement or position determination based on an information on a received reference or received signaling message from a UE or based on the reference signal or signaling message received from the UE; wherein the network entity is configured to output a feedback on the reference signal or the signaling message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

Another embodiment may have a communication system comprising the UE according to the invention as mentioned above and a the TRP according to the invention as mentioned above; and/or the network entity according to the invention as mentioned above.

According to another embodiment, a method for operating a UE, may have the steps of:
receiving one or more first configurations from a network entity (e.g. TRP or LMF) of a wireless network, the one or more first configurations comprising parameters for a reference signal to be transmitted by the user equipment for position determination;
receiving a one or more second configurations from the network entity (e.g. gNB), the one or more second configuration comprising parameters describing an active phase and an sleep phase of an UE activity cycle (e.g. DRX cycle or an eDRX cycle), wherein during the active phase the user equipment is configured to receive one or more signaling messages from the network entity, and wherein during the sleep phase, the UE is temporarily unreachable (e.g. by paging);
transmitting the reference signal according to one of the one or more first configuration and taking into account one of the one or more second configurations (defining the DRX cycle).

According to another embodiment, a method for operating a network entity, TRP or another UE, may have the steps of:
communicating with a UE which is configured to transmit a reference signal and/or to signal a message for a measurement during an active phase of a, DRX, cycle;
outputting a configuration including a validity information or a validity information to the UE, wherein the configuration of the UE is valid for a validity area or wherein the UE is allowed to communicate in accordance to the validity information.

According to another embodiment, a method for operating a network entity, TRP or another UE, may have the steps of:
providing one or more first configurations to an user equipment, the one or more first configurations comprising parameters for a reference signal to be transmitted by the user equipment for position determination;
providing a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from the network entity, and wherein during the sleep phase, the UE is temporarily unreachable (e.g. by paging);
so that the user equipment is enabled to transmit the reference signal according to one of the one or more first configuration and taking into account one of the one or more second configurations (defining the DRX cycle).

According to another embodiment, a method for operating a network entity or LMF, comprising the steps:
performing a measurement or position determination based on an information on a received reference or received signaling message from a UE or based on a reference signal or message received from the UE;
outputting a feedback on the reference signal or the message; wherein the feedback indicates one of the following:
incorrect or correct receipt of a reference signal and/or the message at a TRP or another UE, e.g. using ACK/NACK;
incorrect or correct receipt of the reference signal and/or the message at the TRP or another UE and insufficient or sufficient information to be extracted from the reference signal and/or the message to perform a measurement or position determination;
insufficient or sufficient information to be extracted by the LMF from the reference signal and/or the messaging to perform the measurement or the position determination;
the failed or successful measurement or position determination performed by the LMF.

Another embodiment may have a non-transitory digital storage medium having a computer program stored thereon to perform the methods according to the invention as mentioned above when the computer program is run by a computer.

An embodiment of the present invention provides a user equipment in a wireless network, the user equipment comprising a transceiver which is configured for the following task:
receiving one or more first configurations from a network entity (e.g. TRP or LMF) of the wireless network, the one or more first configurations comprising parameters for a reference signal to be transmitted by the user equipment;
receiving a one or more second configurations from the network entity (e.g. the gNB), the one or more second configuration comprising parameters describing an active phase and an sleep phase of an UE activity cycle (e.g. DRX cycle or an eDRX cycle or a hyper DRX cycle), wherein during the active phase the user equipment is configured to receive one or more signaling messages from a network entity, and wherein during the sleep phase, the UE is temporarily unreachable (e.g. by paging);
transmitting the reference signal according to one of the one or more first configuration and taking into account one of the one or more second configurations (defining the DRX cycle).

Another embodiment provides a network entity, like a transmission point or another UE which is configured
to provide one or more first configurations to an user equipment, the one or more first configurations comprising parameters for a reference signal to be transmitted by the user equipment during a particular RRC state (e.g. RRC_INACTIVE) to enable position determination;
to provide a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging); so that the user equipment is
   enabled to transmit the reference signal according to one of the one or more first configuration and/or taking into account one of the one or more second configurations (defining the DRX cycle).

According to another embodiment, a network entity, like a LMF is provide which is configured to receive a measurements other RAN nodes (e.g. TRPs) or position determination based on an information on a received reference or received signaling message from a UE or based on the reference signal or signaling message received from the UE; wherein the network entity is configured to output a feedback on the reference signal or the signaling message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the
   reference signal and/or the message to perform a measurement or position determination;
insufficient or sufficient information to be extracted by a LMF or a TRP from the
   reference signal and/or the messaging to perform a measurement or position determination;
failed or successful measurement or position determination performed by a LMF.

According to embodiments, the three embodiments may be implemented as methods, namely as method for operating a UE, method for operating a network entity in terms of a TRP or UE and for operating a network entity in terms of a LMF. The first method comprise the following steps:
receiving one or more first configurations from a network entity (e.g. TRP or LMF) of the wireless network, the one or more first configurations comprising parameters for a reference signal to be transmitted by the user equipment during a particular RRC state (e.g. RRC_INACTIVE) to enable position determination;
receiving a one or more second configurations from the network entity (e.g. the gNB), the one or more second configuration comprising parameters describing an active phase and an sleep phase of an UE activity cycle (e.g. DRX cycle or an
   eDRX cycle), wherein during the active phase the user equipment is configured to receive one or more signaling messages from a network entity, and wherein during the
   sleep phase, the UE is temporarily unreachable (e.g. by paging);
transmitting the reference signal according to one of the one or more first configuration and/or taking into account one of the one or more second configurations (defining the DRX cycle).

The method for operating a NG-RAN node (gNB) further comprises the following steps:
providing one or more first configurations from a network entity (e.g. TRP or LMF) of the wireless network, the one or more first configurations comprising parameters for a reference signal to be transmitted by the user equipment during a particular RRC state (e.g. RRC_INACTIVE) to enable position determination;
providing a one or more second configurations to the UE, the one or more second
   configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging);
communicating with a UE which is configured to transmit a reference signal and/or to
   signal a message for a measurement during an active phase of a (DRX) cycle;
receiving the reference signal according to one of the one or more first configuration and/or taking into account one of the one or more second configurations (defining the DRX cycle).

The method for operating a NG-RAN node (e.g. TRP) comprises the following steps:
Receiving from LMF a configuration of signal parameters transmitted by the UE on which the TRP performs the measurement.
Performing measurement on the SRS transmitted by the UE
Reporting the measurement result to the LMF or the UE, wherein the measurement includes the measured values (e.g. RSTD, ToA, RxTxDiff, RSRP, etc) and/or measurement uncertainty.

According to another embodiment the method for operating a network entity, like an LMF comprises the steps:

receiving measurements from one or more TRPs and/or UE or position determination based on an information on a received reference or received signaling message from a UE or based on a reference signal or message received from the UE;

According to another embodiment the method for operating a network entity, like an LMF further comprises the steps:
outputting a feedback on the reference signal or the message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

The method for operating a network entity/TRP further comprises the following steps:
outputting a configuration including a validity information or a validity information to the UE, wherein the configuration of the UE is valid for a validity area or wherein the UE is allowed to communicate in accordance to the validity information.

According to further embodiments the method may be computer implemented.

### BRIEF DESCRIPTION OF THE DRAWINGS

Embodiments of the present invention will subsequently be discussed referring to the enclosed figures, wherein:

FIG. 1 shows a schematic diagram of a simplified architecture for UE positioning in 3GPP mobile networks according to embodiments;

FIG. 2 shows a schematic representation illustrating depiction of RRC state in the UE according to embodiments;

FIG. 3 shows a schematic flow diagram illustrating the signaling that the signaling for UE Positioning using UL-TDOA as used according to Rel. 17 of specification to discuss the context of embodiments;

FIG. 4a/b/c show schematically diagram for illustrating a DRX cycle to be used in context of embodiments;

FIG. 5 shows schematically a diagram illustrating a procedure to reduce positioning procedure failure due to UE being unreachable before positioning solution is available according to embodiments;

FIG. 6 shows schematically a diagram for illustrating a short DRX to be used in embodiments to illustrate embodiments;

FIG. 7 shows schematically a diagram for illustrating the UE behavior according to embodiments;

FIG. 8a/b/c show a simplified call flow diagram depicting elements of signaling for ensuring the positioning of UE is available in event of (extended) DRX cycle according to embodiments;

FIG. 9 shows schematically a flow chart for illustrating the exchange of messages for position determination;

FIG. 10a/b show schematic block diagrams illustrating communication networks;

FIG. 11 shows schematic block diagram of an in-coverage scenario;

FIG. 12 shows a schematic block diagram of an out-of-coverage scenario; and

FIG. 13 shows a schematic block diagram illustrating a computer system to be used in context of embodiments.

### DETAILED DESCRIPTION OF THE INVENTION

Below, embodiments of the present invention will be subsequently be discussed referring to the enclosed figures, wherein identical reference numeral are provided to objects having identical or similar function, so that the description thereof is mutually applicable and interchangeable.

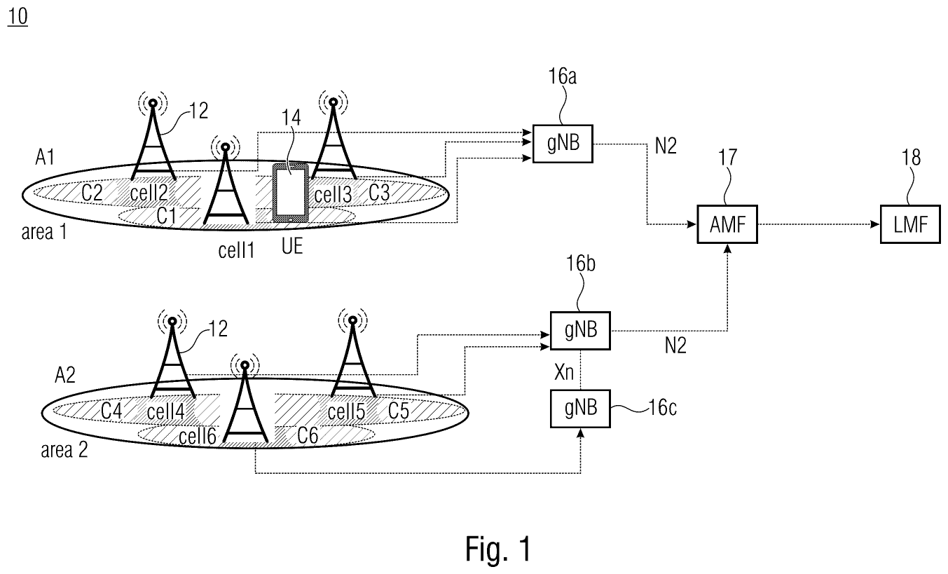

FIG. 1 shows a communication network 10 with two areas A1 and A2. Within each area plurality of cells C1, C2, C3 each having a base station 12 are included. In the area A1 a UE 14 is arranged within area A1.

All base stations 12 of the areas A1 and A2 communicate to respective gNBs 16a, 16b and 16c. The gNBs 16a, 16b and 16c are, vice versa, connected to a localization management function 18 via an access and mobility management function 17.

Since now the major components of the 3GPP 5G system (5GS) 10 are discussed with regard to its structure, the Positioning functionality will be discussed below.

A UE 14 may transmit reference signals, which are received by other entities, such as network entities such as TRPs 12 (in uplink) or other peer UEs (e.g. in Sidelink). Likewise, the UE 14 may receive reference signals transmitted by other entities, such as network entities (such as TRPs 12) or other UEs. The transmitting entity may receive information or instruction on which configuration of reference signal to transmit. Likewise, the receiving entity may receive information or instruction on which configuration of reference signal to measure and to report.

From the radio resource control (RRC) point of view, the UE 14 is either in RRC_IDLE, RRC_INACTIVE or RRC_CONNECTED state. In the RRC_IDLE state, there is no N1 or N2 signaling connection between the UE and the AMF. In the RRC_INACTIVE state, the N2 connection is maintained but the RRC_CONNECTION is suspended. In the RRC_CONNECTED state, full data and signaling connectivity between the 5GC network and the UE 14 is established.

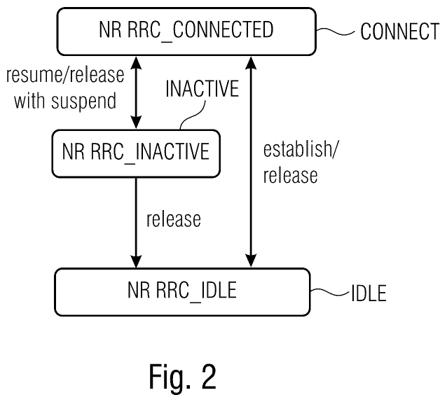

This is illustrated by FIG. 2 showing the resume/release/establish procedure between the different states a RCC_CONNECTED, a RCC_INACTIVE and a RCC_IDLE.

FIG. 2 shows the three states connected, inactive and idle. As illustrated by the three arrows it can be toggled between the three states connected, inactive and idle.

As shown in FIG. 2, the UE which receives the RRCRelease message releases an RRC CONNECTION and enters the RRC_IDLE state. However, if the RRCRelease message is received with an IE suspendConfig, (Release with Suspend), then the UE enters the RRC_INACTIVE state, and the RRCResume message brings the UE back to RRC_CONNECTED state from the RRC_INACTIVE state. Similarly, the RRCSetupRequest message is used by the UE to request the establishment of an RRC connection.

According to Rel. 16 of the 3GPP specifications, the UE needs to transit to RRC_CONNECTED mode to transmit or receive positioning reference signals. This restriction was relaxed in Rel. 17 wherein the UE could perform UE positioning in RRC_INACTIVE state without having to necessarily transit to RRC_CONNECTED state. A UE may be configured to transmit positioning reference signals (such as sounding reference signal for positioning purposes), so that one or more TRP can perform measurements on the transmitted positioning reference signals. Parameters such as RSRP, time of arrival, time difference of arrival, difference in time between the instant when the DL-PRS was sent and the time instant when the UL-PRS is received can be estimated by the TRPs.

Likewise, a UE may be configured to receive and perform measurements on reference signal transmitted by one or more TRPs, wherein the UE may be able to determine RSRP, time of arrival, time difference of arrival or difference in time between the instant of time when the DL-PRS was received and the UL-SRS was sent. The UEs may also be able to measure the reference signals transmitted by one another, and report to the network (e.g. Sidelink).

The measurements from one or more TRPs and/or one or more UEs can be provided to the network entity (e.g. LMF) located in the network (e.g. the core network) to compute the UE position and/or range and/or other location dependent parameters (such as orientation, velocity etc)

According to Rel. 17 of the specifications, a UE may transmit sounding reference signal for positioning, as long as the UE is within the cell which released the UE to RRC_INACTIVE state from its RRC_CONNECTED state. Furthermore, the RSRP of a downlink signal, which was used to determine the pathloss reference, needed to remain within a certain range. Upon cell reselection, the UE had to release its existing SRS configuration and acquire a new configuration from the new cell selected by the UE. This means that with current specifications, the UE cannot continue transmitting positioning reference signals in uplink if the UE performs cell-reselection.

If we consider a simple scenario, where a UE transmits a positioning reference signal which may be received by other entities (e.g. one or more TRPs in the wireless network and/or one or more UEs in the network), the receiving entities can perform measurement and report the measurements to the entity computing the positioning. The entity computing the position (e.g. the LMF) can use the measurements reported by the receiving entities and the position of the receiving entity to compute position of the UE utilizing one or more than one positioning methods (e.g. UL-TDOA) supported by the available measurements.

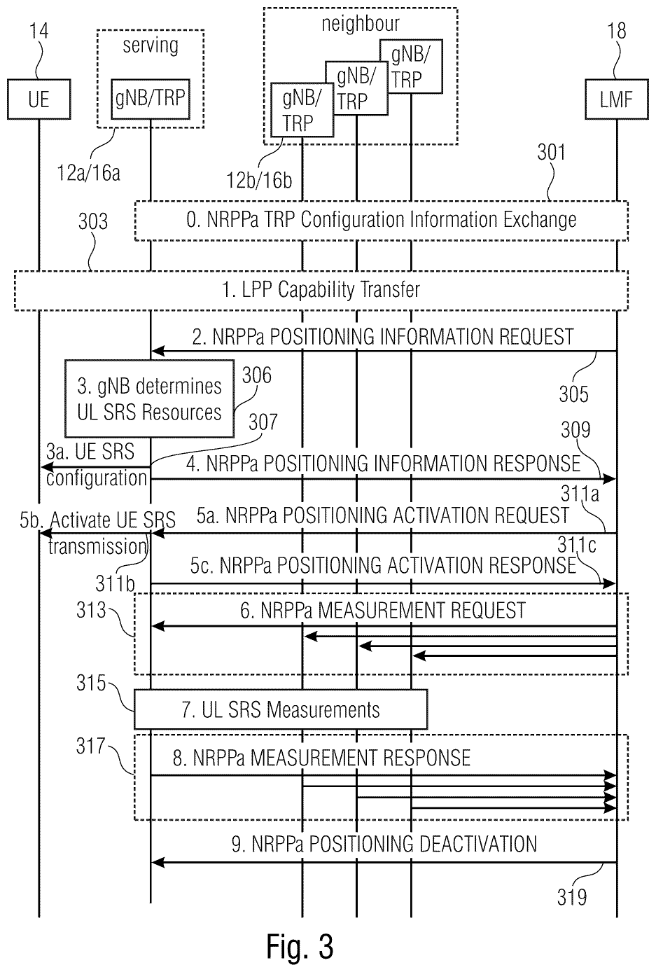

According to Rel. 17 of specifications, the messaging sequence between the LMF, the gNBs and the UE to perform UL-TDOA procedure is as shown in FIG. 3.

FIG. 3 shows a schematic diagram illustrating the signaling for UE positioning. The UE is marked by the reference numeral 10 and communicating with the LMF 18 via the serving gNB/TRP 12a and 16a, wherein also gNBs/TRPs 12b and 16b may be involved. Between the different entities the following information are exchanged.
0. The LMF 18 may use the procedure in FIG. 3 to obtain the TRP information required for UL-TDOA positioning, as indicted by step 301.
1. The LMF 18 may request the positioning capabilities of the target device using the LPP Capability Transfer procedure (see step 303).
2. The LMF 18 sends a NRPPa POSITIONING INFORMATION REQUEST message to the serving gNB 12a/16a to request UL-SRS configuration information for the target device (see step 305).
3. The serving gNB 12a/16a determines the resources (see 306) available for UL-SRS and configures the target device with the UL-SRS resource sets at step 3a, marked by the reference 307.
4. The serving gNB 12a/16a provides the UL information to the LMF 18 in a NRPPa POSITIONING INFORMATION RESPONSE message (see step 309).
5. In the case of semi-persistent or aperiodic SRS, the LMF 18 may request activation of UE SRS transmission by sending the NRPPa positioning Activation Request message to the serving gNB 12a/16a of the target device as described in clause 8.13.3.3a (see 311a). The gNB 12a/16a then activates the UL-SRS transmission (see 311b) and sends the NRPPa positioning Activation Response message, as indicated by 311c. The target device 14 begins the UL-SRS transmission according to the time domain behavior of UL-SRS resource configuration.
6. The LMF 18 provides the UL-SRS configuration to the selected gNBs in a NRPPa MEASUREMENT REQUEST message 313. The message includes all information required to enable the gNBs/TRPs 12a,12b/16a,16b to perform the UL measurements 315.
7. Each gNB 12a,12b/16a,16b configured at step 6/313 measures the UL-SRS transmissions (see step 315) from the target device 14.
8. Each gNB 12a,12b/16a,16b reports the UL-SRS measurements to the LMF 18 in a NRPPa Measurement Response message, as indicasted by step 317.
9. The LMF 18 sends a NRPPa POSITIONING DEACTIVATION message to the serving gNB 12a/16a (see step 319).

In the RRC_INACTIVE mode, a UE has to monitor a much smaller subset of signals compared to the RRC_CONNECTED mode. With DRX, a UE enters periodically in sleep mode during which the receiver and/or transmitter is turned off for an interval configured by the network. A typical DRX cycle consists of active and sleep periods, where during the active period the UE receives and/or transmits signal and during the sleep period, the UE conserves battery power by avoiding transmission and reception of radio signals. It may further turn down the internal circuitry to save power. It is well known that longer the sleep period, the UE cannot be reached, and this increases the network increasing latency. On the other hand, a longer sleep period means low power consumption on average.

This property makes it suitable for reducing power consumption for positioning purposes. One particular use case of such low power positioning is tracking of assets and equipment in warehouses, indoor factory scenarios, airports, hospitals etc. Likewise, wearable tags are other examples of tracking people or goods within a certain scenario. Common to both use cases are the requirement for the device to locate the object or person to which the UE is connected to accurately, while reducing the power consumption thereby increasing the battery life.

Since none of the background for embodiments of the invention has been discussed, the problem will be discussed.

A UE may need to achieve high accuracy but may be restricted in terms of energy consumption. If the update rate of the UE can be limited, then enabling the UE to sleep for most of time and occasionally wake up and transmit/receive reference signals for positioning could enable the UE to meet both goals.

The duration of active phase to the sleep phase in the DRX duty cycle influences the power consumption of the UE. In general, the battery life can be extended if the active phase can be reduced as much as possible. This may include, receiving the minimum system information and ensuring that the SI is up to date, and then transmitting the resource on the configured SRS resource and going back to sleep.

However, it may sometime happen that the measurement made on SRS sent out by the UE in the RRC_INACTIVE may not have resulted in a position estimate with the required quality. This may sometimes not be a problem, if the DRX cycle is short because on the next occasion, the positioning procedure can be repeated. However, if the DRX cycle is long and/or if the UE transmits the SRS only when triggered by an event, then the failure in obtaining position may cause the LCS client to not have any position of the UE at all or have a position of the UE that is insufficient for the given purpose.

If we consider a UE that is designed to save power, and assuming that the UE has no further data to transmit, the UE may into sleep mode after transmitting an uplink positioning reference signal. In Rel. 16 or Rel. 17 of the specifications, there is no mechanism for the network to inform the UE that the SRS it transmitted was successfully (e.g. detected and/or able to perform measurements with certain quality on the received signal) received by the entities that were supposed to receive it.

The lack of acknowledgement of uplink positioning reference signal leads to the situation that the UE's position may not be available at the network side (e.g. at LMF and/or at GMLC) if positioning operation fails. Furthermore, the network does not have a mechanism of paging the UE if positioning operation fails before the sleep phase in current DRX cycle fails or if the UE is configured in mobile initiated connection only (MICO) mode.

Although the above problem is highlighted using UL-TDOA as an example, the problem occurs with any positioning method using uplink positioning reference signal. For example, if the network entity has not received uplink positioning reference signal, then it won't be able to report Rx-Tx-TimeDiff for determining range according to multi-RTT, or AoA.

The problem is particularly made worse in scenarios where extended DRX cycle or even longer DRX cycle is used. If we assume a low power device which wakes up infrequently (e.g. only once per day) to check paging channels, or even devices that have only a MICO mode and assuming that positioning is event triggered, some important information could be lost.

Therefore, there is need for an improved approach. Embodiments of the present invention provide an improved concept which is implemented at a UE as well as network entity, like a TRP or LMF.

An embodiment provides a user equipment comprising a transceiver, wherein the transceiver is configured
to receive one or more first configurations from a network entity (e.g. TRP or LMF) of the wireless network, the one or more first configurations comprising parameters for a reference signal to be transmitted by the user equipment during a particular RRC state (e.g. RRC_INACTIVE) to enable position determination;
to receive a one or more second configurations from the network entity (e.g. the gNB), the one or more second configuration comprising parameters describing an active phase and an sleep phase of an UE activity cycle (e.g. DRX cycle or an
   eDRX cycle), wherein during the active phase the user equipment is configured to receive one or more signaling messages from a network entity, and wherein during the
   sleep phase, the UE is temporarily unreachable (e.g. by paging);
to transmit the reference signal according to one of the one or more first configuration and/or taking into account one of the one or more second configurations (defining the DRX cycle).

The counterpart, namely the transmission point, or in general the network entity also comprises a transceiver and may perform one or more of the following functionalities
to provide one or more first configurations to an user equipment, the one or more first configurations comprising parameters for a reference signal to be transmitted by the user equipment during a particular RRC state (e.g. RRC_INACTIVE) to enable position determination;
to provide a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signals and/or signaling messages from a network entity and wherein during the sleep phase, the UE is temporarily unreachable (e.g. by paging);
so that the user equipment is enabled to transmit the reference signal according to one of the one or more first configuration and/or taking into account one of the one or more second configurations (defining the DRX cycle).

Another entity which interacts with the UE and the TRP is a LMF (general network entity) which may perform the following:
to receive a measurement or position determination based on an information on a received reference or received signaling message from a UE or based on the reference signal or signaling message received from the UE;

The network entity, like an LMF, further comprises the steps:

wherein the network entity is configured to output a feedback on the reference signal or the signaling message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

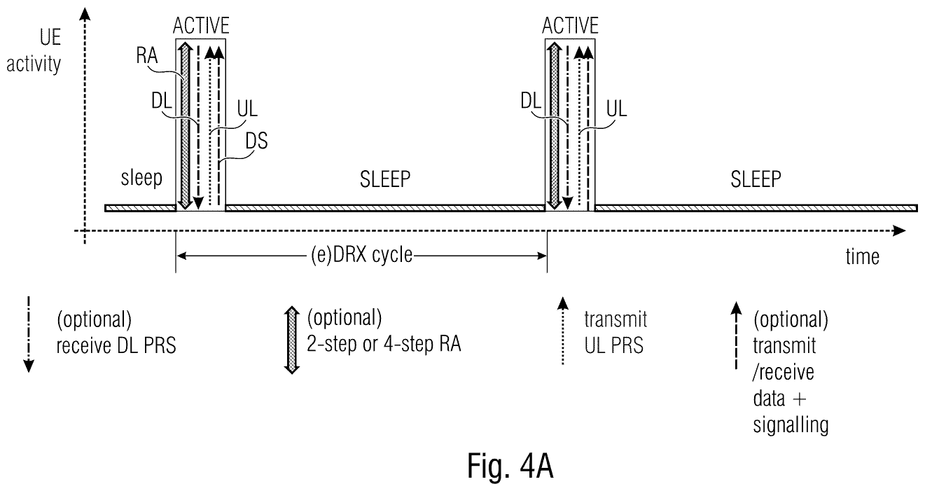

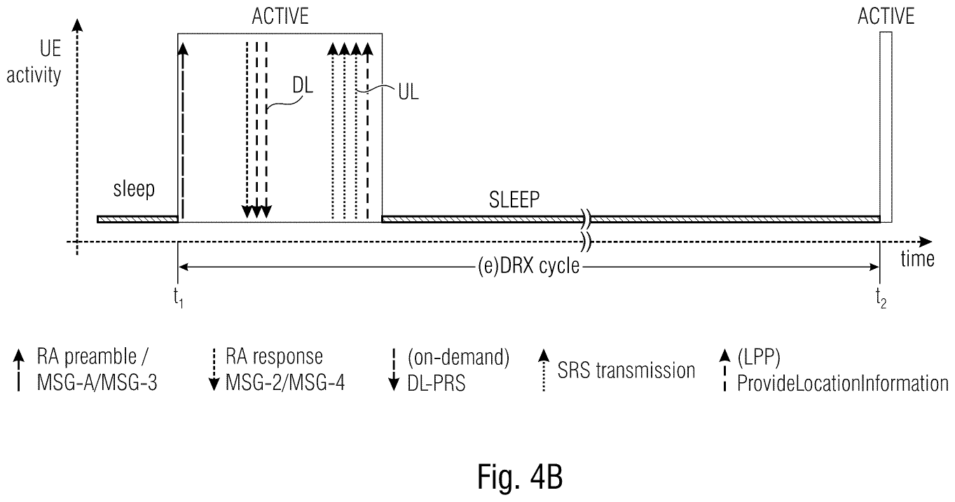

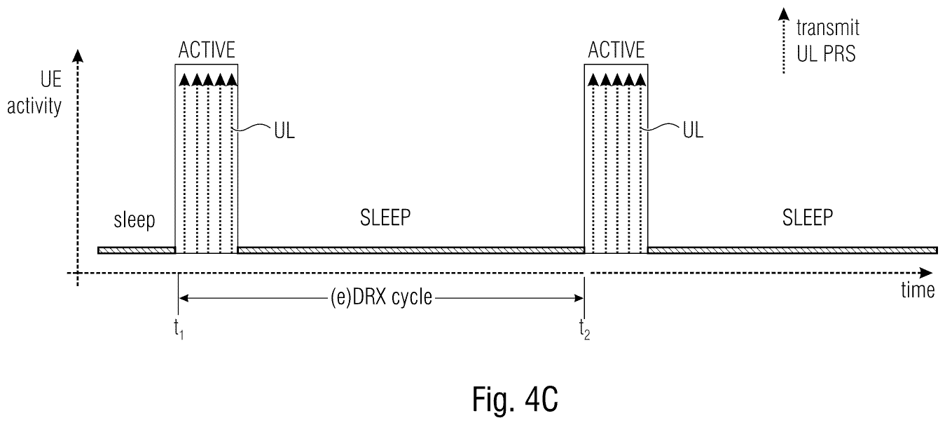

This principle enables especially for discontinued reception cycles, a concept where the parameters for exchanging the reference signal as well as the parameters for controlling the discontinuous reception cycle can be exchanged, so that a good tradeoff between high accuracy and high reliability position determination and energy efficiency can be achieved. With respect to FIG. 4a an embodiment will be discussed. FIG. 4a shows a UE activity with a UE configured for a discontinued reception cycle plotted over the time or over a plurality of (e)DRX cycles. Each DRX cycle is characterized by an active phase followed by a sleep phase. Within the active phase a UL Pos signal can be transmitted and/or DL Pos signal can be optionally received. The Pos signals are reference signals to be used for position determination. The downlink Pos signal is marked by DL, while the uplink Pos signal is marked by UL. These signals can be used for a measurement and/or position determination. Additionally, data and signaling can be transmitted and/or received (cf. reference numeral DS). Additionally, at the beginning of the active phase a 2-step or 4-step random access (cf. reference number RA) may be performed. Such a random access is typical for discontinuous reception cycles, but not necessary (meaning that different access technologies/access protocols may be used).

By exchanging the above-mentioned one or more first configurations (e.g., received from a network entity, like TRP or LMF) the UE receives the parameters to be used for outputting the reference signal (cf. UL DRS). For example, the one or more first configurations may comprise a resource information (indicating time-frequency location for on-demand reference signal or validity information, where the reference signal may be or should be output). The second configurations comprise parameters describing the active and sleep phase, for example the scheduling of the two phases, the periodicity of the two phases, etc. It should be noted that typically, just during the active phase, the user equipment can receive signals from externally, e.g., from the network entity, wherein during the sleep phase the UE is temporary unreachable, e.g., by paging. Vice versa, the reference signal is typically just output during the active phase. Since the active phase is defined in the one or more second configurations the reference signal is transmitted in accordance to the at least one of the one or more first configurations taking into account one of the one or more second configurations. Likewise, the UE may have configuration where the UE may be allowed to transmit (i.e. the UE wakes up to transmit a signal), but the UE may not have configured resources for the network to page the UE (i.e. for the NW to initiate the connection).

FIG. 4b indicates possible components of user equipment positioning with multi-RTT. The active phase may be ended with a positive feedback and/or there may be small DRX cycle within a large DRX cycle as discussed with previous embodiments.

FIG. 4c shows a configuration of active, wherein within the active phase, where periodic or semi-persistent SRS is transmitted. The active phase may be reconfigured when the network has determined the position, enabling the UE to enter into a extended DRX cycle.

Below, an embodiment which ensure accuracy and reliability for the PRS signal will be discussed. It is assumed that during the active phase a reference signal is output. According to embodiment a feedback information regarding the reference signal, e.g., an acknowledgement, or non-acknowledgement command can be received from a network entity, like the TRP or the LMF. For example, the LMF may output a feedback informing the PRS transmitting UE, that the PRS signal has been correctly received and the position calculation was or could be performed correctly. In order to ensure, that the feedback signal is not transmitted during a phase, wherein the UE is unreachable, the UE takes into account the second configurations. For example, by use of the second configurations the active phase can be extended, so that the UE is configured to receive the feedback. The procedure can be as follows: according to embodiments to ensure that the UE does not enter the sleep phase before the result of UE positioning is available at the network side, the following steps are taken:
1) The UE transmits a reference signal and/or signaling message(s) containing measurements within the active phase of the DRX cycle, according to provided configuration, wherein the provided configuration is valid within an area, such as a group of cells.
2) The UE is configured with feedback resources or an acknowledgement window, wherein the UE listens to acknowledgment of completion of positioning procedure.
3) If the UE detects a positive acknowledgment or an implicit positive acknowledgment, then the UE enters the sleep phase of the DRX cycle. If it receives a negative acknowledgment or implicit negative acknowledgment, then the UE interacts with the network to enable the network to obtain the UE position.

This means that, the active phase is enhanced up to the point of time, where a positive acknowledgement command is received.

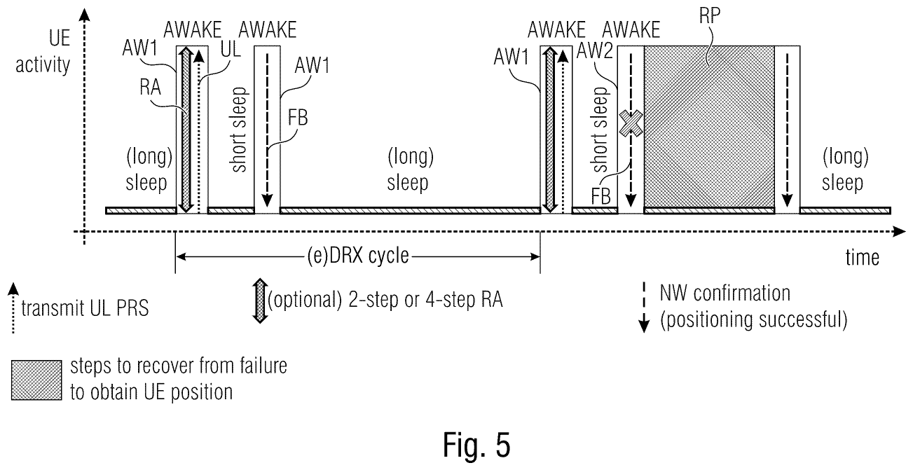

According to embodiments the UE may fall into a short sleep after transmission of the UL-PRS (e.g. using one of the first configuration provided to the UE) and return into a awake state for receiving the feedback signal. This is illustrated by FIG. 5.

FIG. 5 shows an activity diagram plotting the UE activities over the time. Here an active/awake phase AW1 is illustrated after a (long) sleep, within which the UL-PRS signal is transmitted. The optional 2-step or 4-step RA procedure is illustrated as well. After the first awake phase, a short sleep phase follows, before the UE returns into the awake star AW2.

During this awake phase AW1, a UE may have been configured with a feedback resource, wherein the feedback confirmation FB is received indicating that the positioning can be performed successfully or has been performed successfully. After that feedback, the UE may fall into a (long) sleep phase before the next discontinuous reception cycle begins again with AW1 followed by a short sleep. Here during AW2 no network confirmation FB is, for example, received, so that a recovery procedure RP can be performed. This recovery procedure may, for example, comprise a repeated transmission of the UL-PRS signal. In each case (received or not received feedback (positive or negative feedback)) the procedure reduces the positioning failure, since the UE is reachable up to the point of time where the positioning solution is available.

Below, examples for the configuration of the UE will be discussed, wherein the discussed configurations enable, first, to set up the UE for receiving and/or outputting PRS signals and, second, for taking into account the UE activity cycle (e.g., DRX or eDRX cycle) for example, the UE may be configured or preconfigured with the one or more first and/or second configurations based on same the positioning reference signals can be transmitted by the UE.

The configuration contains information regarding the time and frequency allocation of the RE used to transmit the reference signal, the parameters determining the length of sequences and/or the sequences used for transmitting the reference signal. Furthermore, the configuration may contain identifiers to identify a particular configuration uniquely among the set of configurations available to the UE, if the UE is provided more than one configuration. Specifically, the configuration may contain some or all of the following parameters:
srs-PosResourceSetID
srs-PosResourceId
transmissionComb
transmissionCombOffset
resourceMapping
freqDomainShift
freqHopping
groupOrSequenceHopping-r16
resourceType

A UE may be provided a particular configuration, while the UE is in a certain RRC state or in one of certain RRC states. For example, a UE may be provided a configuration which can be used in RRC_INACTIVE state only. Likewise, A UE may be indicated that it may use a configuration both while the UE is in RRC_INACTIVE or RRC_CONNECTED state. Alternatively, a UE may be provided different configurations, wherein the UE is indicated the conditions when the configurations may be used.

Furthermore, if a UE is configured with multiple configurations, a configuration may further be associated with certain type of location request. For example, there may be different configurations provided to the UE to use with different type of location requests, such as immediate location request or deferred location request or scheduled location request or location request based on events. Furthermore, a configuration could be associated to at least a quality parameter, wherein a particular configuration the UE selects for transmission is associated with quality parameters such as update rate, sleep duration, latency.

Furthermore, the configuration may be selected based on measurements, such as measurement of reference signals transmitted by one or more TRPs.

Likewise, a UE may be provided one or more configurations, wherein a particular configuration is mapped to a particular area within the wireless communication network. A UE may be provided with one configuration which may be used within a particular area. Alternatively, a UE may be provided with more than one configurations, wherein each configuration carries an indication about the area in the wireless network where it is valid.

As part of the one or more first configurations an information on validity area of configuration may be exchanged.

According to Rel. 16 and Rel. 17 of the specifications, the SRS configuration provided to the UE is valid as long as the UE has not performed cell-reselection.

If a UE can be provided with configuration that is valid beyond the cell where the UE received its configuration, then positioning continuity can be ensured as the UE can reselect the cell and continue transmission. To do so, the UE needs to be provided with assistance from the network on autonomously selecting spatial relation and/or timing advance to be used.

The validity area may be one or more of the following:
a group of cells on the same carrier bandwidth
RAN notification area and/or the tracking area,
system information area,
a cell
a certain part or portion of a cell, or a certain part or portion of the RAN notification area, or a part or a certain portion of the system information area or a part or a portion of the positioning system information area, each being denoted by an appropriate area identifier,
certain parts or portions of at least two cells,
V2X Zone
Geographical area described by GAD.
Area wherein a UE is within the region handled by a certain network entity, e.g. within the group of cells hosted by a gNB or a network equipment.

Below three different cases according to three embodiments which can be used independently or in combination will be discussed.

Case 1: Embodiment for UE reselecting within one of the cells in validity area and SRS transmission ongoing: If a UE performs cell-reselection in one of the cells within the validity area or the UE remains in the same cell that provided the SRS configuration and/or TA parameters, and SRS transmission is ongoing, then the UE performs validation of TA or the UE updates the timing advance autonomously. If the TA can be validated, then the UE continues to transmit using the configuration. If the TA cannot be validated, the UE performs the random access procedure to acquire new TA value.

### Validation Procedure

The validation according to an embodiment involves storing the RSRP of the downlink pathloss reference signal with the current RSRP value measured on the downlink pathloss reference signal indicated in the first configuration, and determining the whether the stored pathloss value and the current pathloss value has not increased by more than a threshold.

Case 2: Embodiment for UE reselecting within one of the cells in validity area and SRS transmission not ongoing but need to start: If a UE performs cell-reselection in one of the cells within the validity area, and the UE needs to start transmitting SRS transmission (e.g. due to higher layer trigger, etc), then the UE performs random access procedure to acquire timing advance. Furthermore, the UE also indicates the network to activate the first configuration (for example by sending a RRC Resume Request, indicating the network to activate a preconfigured SRS). This means the other TRPs begin performing measurement on the SRS transmitted by the UE. Then the UE proceeds to transmit with the configured SRS. The SRS is preconfigured to the UE, meaning that the UE has received at least one first configuration, where the UE does not immediately start transmission.

Case 3: Embodiment for UE reselecting within one of the cells outside validity area and SRS transmission is ongoing: If the UE performs cell-reselection in one of the cells outside the validity area, then the UE stops the ongoing transmission, and the UE needs to indicate to the RAN-node (e.g. serving cell) and request a new configuration of SRS (for example by sending a RRC Resume Request, indicating the network to provide a new configuration). The new configuration may have a validity within the serving cell or it may have validity within a group of cells.

According to an embodiment for all cases: Furthermore, the time validity of the first configuration has not expired (i.e. the configuration is within the validity time of the configuration).

According to an embodiments, the stored RSRP can be updated:

The stored RSRP is updated when the UE performs one out of the following:
1) Obtains at least one first configuration valid in the area where the UE is camped.
2) Obtains a timing advance command from the network, wherein the network indicates either a particular value of timing advance to use or where the network indicates the UE an adjustment to the existing value of timing advance.
3) UE is capable of adjusting the timing advance autonomously, either on its own by implementation or based on assistance data from the network.

If a UE is configured with at least one first configuration, which is valid in a cell and the UE is—according to an embodiment—configured another first configuration which is also valid in an area, then the UE selects the valid configuration. If there are two configurations that are signalled to the UE that have the same cell indicated in the validity area, then the first configuration which is configured to be immediately used precedence over the first configuration which is configured for later point in time. Alternatively, the latest provided configuration overwrites the first configuration.

According to an embodiment, the configuration and the validity area where the configuration is valid on is determined by one or more network entities interacting with each other. The LMF may determine a configuration of uplink positioning resource for a given UE or a given group of UEs, and select a subset of cells where the configuration is potentially valid. The subset of cells selected by the LMF may be based on the information obtained by requesting the TRP information from NG-RAN nodes during initial setup and/or O&M and/or other network functions (e.g. the NRF). The LMF requests the cells to reserve the configuration requested and awaits response from the cells. Based on feedback from the cells, the LMF determines the validity area. For example, a subset of cells that sent positive response to the LMF could be selected as a validity area for the given configuration.

The configuration and/or its associated validity area may be broadcasted by the cells within its validity area. Alternatively, the configuration is provided by unicast to a UE.

According to embodiments, the user equipment selects the one first configuration from the one or more first configurations and/or the one second configuration from the one or more second configurations according to a selection criterion or a selection criterion signaled to the user equipment.

According to embodiments, the selection criteria is based on at least one of the following:
validity area (configured to the UE);
validity time
event or type of the event (e.g. triggered by higher layers in the protocol stack of the UE);
periodicity of positioning
timing advance and/or predictability, especially whether or not timing advance can be determined by the UE or the previously determined timing advance can be validated by the UE;
MICO mode.

According to embodiments, the UE is configured with at least one feedback resource, which the transceiver is configured to monitor to receive feedback from at least one network entity; Alternatively, the UE is configured with at least one feedback resource, which the transceiver is configured to monitor to receive feedback from at least one network entity and wherein the feedback indicates whether or not the positioning procedure has successfully completed and/or the measurement made by at least one TRP meets the needed quality.

According to embodiments, the feedback resource comprises of a configured resource or a group of resources within a configured window, wherein the user equipment is configured to take an action depending on the type of feedback received during the feedback resource.

According to embodiments, the user equipment is configured to enter a sleep state if a positive feedback is received during the feedback resource. Additionally or alternatively, the UE is configured to initiate one or more recovery procedures to enable the network entity to determine the UEs position. Additionally or alternatively, the transceiver is configured to transmit the reference signal during an active phase of the UE activity cycle and to enter a sleep phase of the UE activity cycle dependent on a sleep criterion.

According to embodiments, the sleep criterion is fulfilled, when a feedback is received or when a feedback is received and the feedback is a positive feedback.

According to embodiments, the feedback indicates one of the following:
incorrect or correct receipt of the reference signal and/or the message at a TRP or another UE, e.g. using ACK/NACK;
   incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF or wherein a positive feedback indicating one of the following:
correct receipt of the reference signal and/or the message at a TRP or another UE, e.g. using ACK/NACK;
correct receipt of the reference signal and/or the message at a TRP or another UE and sufficient information to be extracted from the reference signal and/or the message to perform a measurement or position determination;
sufficient information to be extracted by a LMF from the reference signal and/or the messaging to perform a measurement or position determination;
successful measurement or position determination performed by a LMF.

According to embodiments, the feedback may be any one of the following type:
an implicit positive feedback, wherein no feedback received by the UE is considered positive feedback;
an implicit negative feedback, wherein no feedback received by the UE indicates a negative feedback;
an explicit positive and an explicit negative feedback, wherein no feedback received by the UE triggers a fallback procedure;
an indication to transmit reference signal with a configuration different to the first configuration, by providing an identifier indicating one of the configuration, or one configuration from a group of configurations, or by providing a new configuration.

According to embodiments, the transceiver is configured to listen for the feedback or listen for a feedback via a feedback resource and/or during an feedback window.

According to embodiments, the feedback resource occurs in time after transmitting.

According to embodiments, the feedback resource is only used, when the sleep phase of the (DRX) cycle is larger than a threshold value signaled by the network. Additionally or alternatively, the (DRX) cycle may be a small or medium or large (DRX) cycle and wherein the feedback resource are only used, for a large (DRX) cycle.

According to embodiments, the feedback resources may be any of the following:
configured resources in downlink (e.g. PDCCH/PDSCH) and/or sidelink (PSSCH) wherein a RRC message and/or LPP and/or NAS-DL message is included by the configured resources;
MAC-CE Transmitted From the gNB to the UE on downlink;
MAC-CE transmitted using small data transmission mechanism;
the one or more first configurations of resources indicating time-frequency location for on-demand reference signal;
resources associated to the one or more first configurations belonging to the reference signal;
A configuration of a DL-PRS resource, which is transmitted on-demand from a network entity (e.g. in response of certain events, such as successful reception of the positioning reference signal or failure to measure a certain configuration of UL-PRS signal).

Note the one or more first configuration according to above definition may be associated with a configuration on an on-demand DL-PRS resource, wherein a UE
a UE transmits a reference signal (e.g. a selected first configuration),
checks if it receives a DL-PRS resource, whose measurement (e.g. RSRP) is above a certain threshold.
If it does, then it transmits a configured positioning resource (first configuration) associated with this DL-PRS.

Alternatively, a UE is configured with a DL-PRS, and if a UE does not measure a DL-PRS above a certain threshold, it transmits a reference signal and waits for response in the feedback resource. In line with this embodiment, the UE may provide the RxTxTimeDiff, the difference in time between which the UE received its downlink reference signal and the time when the UE transmitted its UL RS to the network.

According to embodiments, the transceiver is configured to perform the transmission taking into account a validity area information or a validity area information included by the one or more first configurations or only if the UE is arranged within a valid area according to a validity area information.

According to embodiments, the sleep phase comprises an inactive or an idle state of the transceiver.

According to embodiments, the (DRX) cycle is a short (DRX) cycle or long (DRX) cycle, wherein the long (DRX) cycle is configured with the transmission of the one or more first configurations and wherein the short (DRX) cycle is configured, so that the active phase contains a feedback resource.

According to embodiments, the transceiver is configured to interact with a TRP, LMF or network for performing position determination if the transceiver receives a negative feedback (NACK) or implicitly receives a negative feedback or to perform a recovery procedure.

According to embodiments, the recovery procedure comprises one of the following:
entering RRC connected state and/or CM connected state so as to enable the network to initial a new position procedure with the UE (e.g. determining the UE position with alternative position methods, such as using multi-RTT);
requesting the network to use a different first configuration from a set of one or more first configurations or preconfigured one or more first configurations,
selection of a configuration (different to the one originally selected) from the set of one or more configurations provided to the UE, and transmitting the reference signal according the newly selected configuration;
selection of a configuration (different to the one originally selected) from the set of one or more configurations provided to the UE, and indicating to the network entity the configuration used by the UE;
selection of a configuration (different to the one originally selected) from the set of one or more configurations provided to the UE, and requesting the network entity to grant the configuration selected by the UE;
retransmission of the signal.

According to embodiments, the transceiver is configured to transmit according to one or more first and/or second configurations or to transmit according to provided one or more first and/or second configurations being valid within an area such as a group of cells.

According to embodiments, the one or more first and/or second configurations are provided by the network, the TRP or preconfigured.

According to embodiments, the one or more first and/or second configurations comprises time and frequency allocation and/or parameters determining lengths of sequence(s) and/or sequence(s) used for transmitting the reference signal.

According to embodiments, the one or more first and/or second configurations comprises one or more of the following parameters:
identifiers to identify a particular configuration unique among a set of the first and/or second configurations available to the UE, if the UE is provided with more than one configuration:
srs-PosRresourceSetID
srs-PosResourceSetID
transmissionComb
transmissionCombOffset
resourceMapping
freqDomainShift
freqHopping
groupOrSequenceHopping-
resourceType.

According to embodiments, wherein the UE is configured to receive a configuration or reference signal configuration while the UE is in a certain RRC state or in one of certain RRC states.

According to embodiments, the one or more first and/or second configurations are differentiated for an active phase or sleep phase; and/or

wherein the one or more first and/or second configurations comprises parameters controlling the sleep phase. Additionally or alternatively, a suspend configuration of the configuration contains information about feedback resource(s).

According to embodiments, the one or more first and/or second configurations are mapped to one or more areas/cells.

According to embodiments, the one or more first and/or second configurations comprise multiple configurations (e.g. associated with certain type of location requests).

According to embodiments, each of the one or more first and/or second configurations is valid for one or more areas or cells or valid beyond a cell. Additionally or alternatively, each of the one or more first and/or second configurations includes information on validity (e.g. validity area may be signaled as a group of cells on same carrier bandwidth).

According to embodiments, the feedback resource is associated with the one or more first configurations.

According to embodiments, the transceiver is configured to transmit in accordance to a validity area information, wherein the validity area information comprises one of the following:
a group of cells on the same carrier bandwidth;
a RAN notification area and/or tracking area;
a system information area;
a cell
a certain part or portion of a cell, or a certain part or portion of a RAN notification area, or a part or a certain portion of the system information area or a part or a portion of the position system information area, each being donated by an appropriate area identifier;
certain parts or portion of at least two cells;
V2X Zone;
geographical area described by a GAD;
area, where a UE within the area is handled by a certain network entity, e.g. within the group of cells hosted by a gNB or network equipment.

According to embodiments, wherein the transceiver is configured to enter a sleep phase for a short (DRX) cycle after transmitting and before expecting feedback.

According to embodiments, the reference signal is output based on location request, predictable request, or non-predictable request or event driven, e.g. UE available, motion of UE, detection of activity, entering a certain area, higher layer trigger, being outside of the validity area.

According to embodiments, the transceiver is configured to transmit the reference signal according to the one or more first configurations, if it has been configured with a TA or its last configured TA is valid or if the UE has been provided with the one or more first configurations or information enabling the UE to select its timing advance.

According to embodiments, the transceiver may be configured to transmit the reference signal according to the one or more first configurations, if it has been configured with a spatial relation, indicating to the UE to use a certain UE beam for transmitting. According to embodiments, the transceiver may be configured to transmit the reference signal according to one or more first configuration, wherein a specific first configuration from a set of first configurations signals the network that the transmission is UEs last positioning signal (last positioning signal indication) or last message before the UE goes to sleep. According to embodiments, the UE receives the feedback resource after transmitting signal after sending last positioning signal indication and/or a last message, wherein responsive to receiving the positive feedback, the UE enters the sleep mode and wherein responsive to receiving a negative feedback, the UE initiates the recovery procedures.

According to embodiments the UE may be configured for a discontinued reception (DRX).

According to an embodiment, a UE may be configured with parameters controlling its sleep state. During the sleep state, the UE may reduce its activity (e.g. transmission and/or reception) to conserve the battery power. A UE may be configured with a DRX cycle or an extended DRX cycle. The DRX cycle may be a few subframes, a few radio frames or a few hyper system frames. The UE may be configured with parameters determining the wake up phase.

For example, the validity area may be signaled as a group of cells on the same carrier bandwidth, where the UE may use the configuration provided to the UE for transmission and/or the UE may indicate to the network that the UE intends to use the configuration for transmission.

According to embodiments the feedback of outcome of positioning procedure may be as follows.

When a UE is configured with DRX cycle, the UE transmits PRS during the active portion. The signal needs to be received by multiple TRPs (selected by the LMF) and the measurement needs to be provided to the LMF. In some cases, problems may arise in determining the position, such as when one or more TRPs are unable to estimate signal parameters with required quality or were unable to receive the signal. In such situations, the network may want to use a different position method and/or change parameters for transmission and/or require the UE to retransmit the signal. However, due to DRX, the UE is not reachable by the network until the UE is out of sleep mode. Particularly, if the UE is MICO only device, then the position is not available at the network until the UE reinitiates the connection.

The problem can be solved when a UE an extended sleep after receiving confirmation from the network that the positioning operation is successful.

According to an embodiment, a UE is configured with at least one resource wherein the UE monitors the feedback from the network indicating to the UE whether or not the positioning procedure has been successful. The resource occurs in time after the UE has transmitted the SRS. There may be optionally a short sleep (for example, with a shorter DRX cycle).

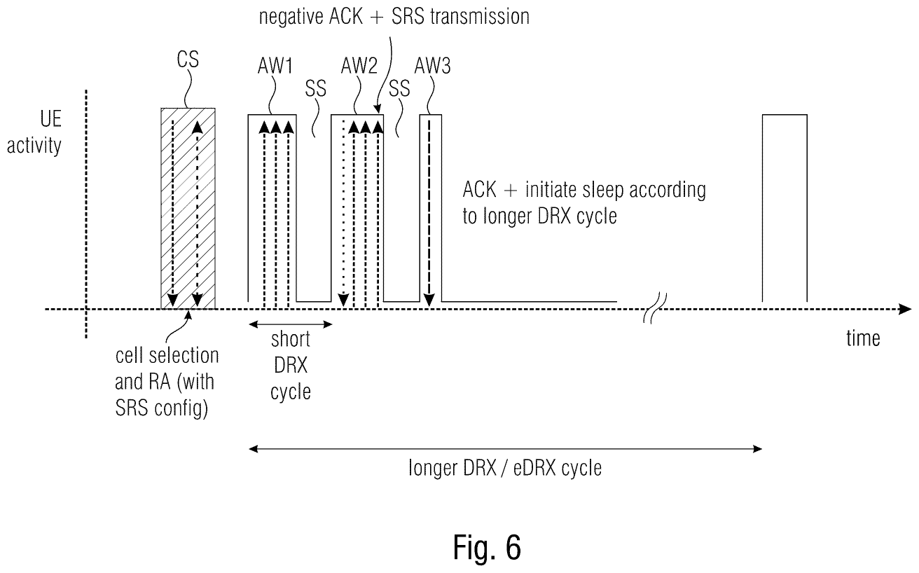

This is illustrated by FIG. 6 showing a diagram for illustrating the UE activity plotted over the time. In this example, a UE performs the cell reselection within a validity area, or it may want to transmit a reference signal at time when the network may not be anticipating to receive the positioning reference signal. The Ue may perform (optionally), the 2-step or 4-step RA procedure is illustrated as well. The situation may indicate a transmission which has not be scheduled by the network, which means one or more TRPs in the network may not be processing the transmission. This means, the UE needs to signal the NW to prepare for transmission. This information may be carried within the random access message (e.g. MSG-A or MSG-3). Alternatively, the UE may be configured with a set of preambles, whose transmission indicates the intention of the UE to use a particular SRS configuration in the next slot. The response of RA (e.g. MSG-B or MSG-4) may indicate the UE that the network is ready to process the signal indicated by the UE. Alternatively, the network may provide alternate configuration. In one example, the MSG-A or MSG-3 contains RRCResume message, send by the UE, and the UE may indicate the network that it is requesting a SRS configuration, by indicating to the network that the UE is requesting a configuration of positioning SRS resources for the uplink for RRC_INACTIVE state (e.g. by including a enumeration indicating request of positioning SRS or by indicating request of positioning SRS for a particular RRC mode, RRC_INACTIVE). The network may either respond by sending the RRCSetup message or the network may respond by sending RRCRelease with suspendConfig. If the network responds with RRCSetup message, the network may send a RRCReconfiguration message containing the positioning SRS for RRC_INACTIVE mode or the network may follow this with a RRCRelease with a suspendConfig.

The RRCRelease with suspendConfig contains the configuration of SRS to be used by the UE for positioning. The configuration provided in suspendConfig or in RRC_Reconfiguration message may be further associated with the validity area, where the UE may transmit the SRS using this configuration as long as it is within one of the cells or within the area indicated.

Furthermore, the area where the SRS is configured for the UE may comprise a large number of UEs. The NG-RAN nodes/TRP that receive the MSG1 (i.e. PRACH preamble) with a certain configuration provided by the network start processing the SRS configuration mapped to or associated with this preamble. This ensures that a subset of TRPs that are within the vicinity of the UE receive and process the SRS signal. This may help the network nodes reduce power consumption.

Furthermore, in this example, a short DRX cycle as part of a longer DRX/eDRX cycle is used. The short DRX cycle together with a long DRX cycle follows a so-called cell selection and random access (with SRS configuration) phase marked by CX. The short DRX cycle comprises an active/awake phase AW1 followed by a short sleep phase SS. After this short DRX cycle another short DRX cycle may be followed which comprises a W2 and SS. In a short DRX cycle an awake phase AW3 is arranged. Within the first awake phase AW1 SRS transmission is performed. The second awake phase AW2 include resources for feedback transmission/feedback reception. Here a negative feedback, (cf. negative ACK) is received, as illustrated by the broken lines. Within the same, resources AW3 another SRS transmission, e.g., a repetition SRS is transmitted. Within the third awake phase AW3 a positive feedback (cf. ACK) is received, so that the sleep phase according to a longer DRX cycle can be initiated.

The periodicity of the SRS may be smaller than the DRX cycle or an eDRX cycle. The UE may transmit only the occasion of SRS that occur within the active part of the DRX cycle. As an example, a UE may be configured with SRS with periodicity of 10 ms, and four SRS occasions fall within the active cycle (e.g. 40 ms), then the UE transmits the four SRS and goes to sleep. The sleep may be a short DRX cycle. A UE may be configured with a feedback resource, where the UE receives indication from the network whether positioning with its previous SRS transmission was successful or not. If the feedback is negative, depending on UE configuration, then the UE performs retransmission or transmission according to new configuration provided by the network, or may request a new configuration from the network. In the above example, it is considered that the UE is configured to retransmit in case of negative acknowledgment. Therefore the UE retransmits the SRS and goes to sleep according to short DRX cycle, waking up to receive the next feedback slot. In the next feedback resource, the UE receives a positive feedback, therefore the UE goes to an sleep according to a longer cycle.

A positioning procedure may be considered successful if one or more location dependent parameters (e.g. UE position, UE velocity, UE orientation . . . etc) at the network side could be estimated and/or estimated with the required and/or expected quality.

According to an embodiment, the network entity determining the position (e.g. the LMF) indicates to the gNB hosting the cell where the UE last received its suspendConfig that the position estimation has been successful. This may be done for example, by sending out an NRPPa message to the gNB, wherein the NRPPa message contains indication of successful positioning operation.

In response to the message containing indication of successful positioning operation, the NG-RAN node shall indicate to the UE on the feedback resource that the positioning has been completed.

Alternatively, the UE may receive an LPP message from the LMF or a DL NAS message from an AMF indicating that the positioning has been successful or has not been successful. In response to receiving positive confirmation on the feedback resource from NG-RAN node and/or from a core network entity (e.g. LMF, AMF, GMLC), the UE may enter the sleep portion of the DRX cycle.

In response to receiving negative confirmation on the feedback resource, the UE initiates mechanism to help the network to recover from the failure to obtain UE position. The mechanism could be any one of the following:
1) Entering RRC_CONNECTED state and/or CM_CONNECTED state, enabling the NW to initiate a new positioning procedure with the UE (e.g. determining the UE position with alternative positioning methods, such as using multi-RTT)
2) Requesting the network to use a different configuration from the set of preconfigured configurations.

According to an embodiment, the feedback resource could be:
1) A configured resource in the downlink (e.g. PDCCH/PDSCH) and/or sidelink (PSSCH) wherein a RRC message and/or LPP and/or NAS DL message is received.
2) A MAC-CE transmitted from the gNB to the UE on downlink.
3) A MAC-CE transmitted from the gNB to the UE on downlink, particularly using the small data transmission mechanism (e.g. on configured downlink grants).
4) A configuration of resource indicating time-frequency location for on-demand reference signal.
A downlink reference signal indicating a acknowledgement or negative acknowledgement, for example, using certain configuration of downlink reference signal (e.g. a certain sequence) to indicate acknowledgement and a certain configuration (e.g. a certain sequence) to indicate negative acknowledgement.
Alternatively, presence of a signal indicates an implicit positive acknowledgement and vice versa.
5) A Paging occasion, where a UE is paged (to deliver a positive or a negative acknowledgment according to configuration).

According to an embodiment, the configuration of the resource may be provided to the UE using the RRCRelease message, wherein the suspendConfig contains the information about the feedback resource. The feedback resource may be associated with a configuration of positioning reference signal configuration.

According to an embodiment, the feedback resource may be associated to a configuration of SRS the UE is configured to transmit. In line with this an example, the UE is configured to listen to the feedback resource after transmitting the uplink reference signal according to configuration for positive or negative acknowledgement. The UE further takes steps depending on positive or negative acknowledgement.

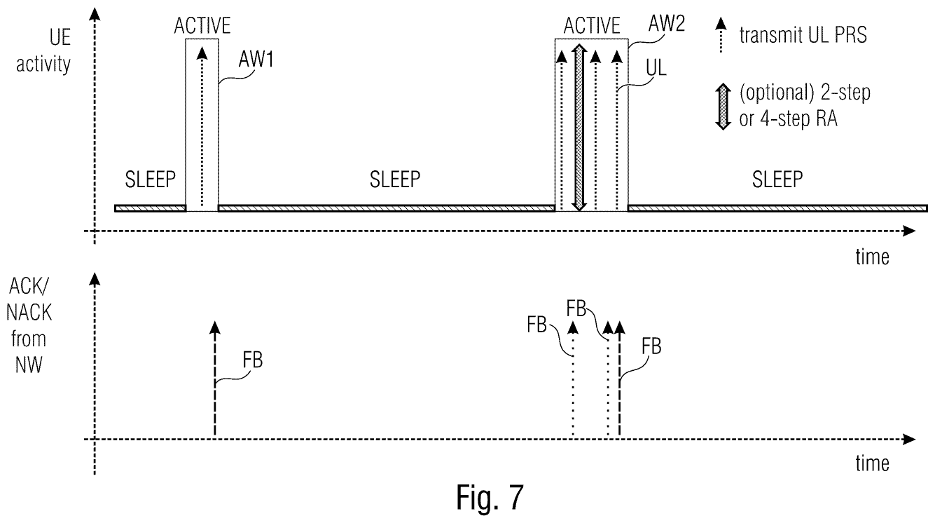

FIG. 7 shows two diagrams plotting the UE activity over the time together with the transmission of the ACK/NACK from the network/network entity. The awake phases are marked by the reference numeral AW1, AW2, wherein during the awake phases the UL-PRS (cf. reference numeral UL) is transmitted. The ACK and the NACK are marked ACK/NACK as reference numerals

According to an embodiment, the UE may be configured with one or more sleep intervals between the time the uplink reference signal is transmitted and the time instant the feedback is received. The SRS transmitted by the UE are received by one or more TRPs. The network entity which has configured one or more gNBs to measure and report on the SRS transmitted by the UE receives the measurement reports from the TRPs. The network entity then attempts to determine the location dependent parameters from the UE. There is a latency involved between the time the UE has transmitted the SRS and the time the LMF has determined the position of the UE to be available. Therefore, to save energy at the UE, the UE may be configured with a sleep intervals between the transmission time and the time the position is available at the LMF. The LMF may then send the acknowledgment to the gNB hosting the cell which the UE has selected. Then the gNB (serving cell) transmits feedback to the UE from the cell on configured feedback resource.

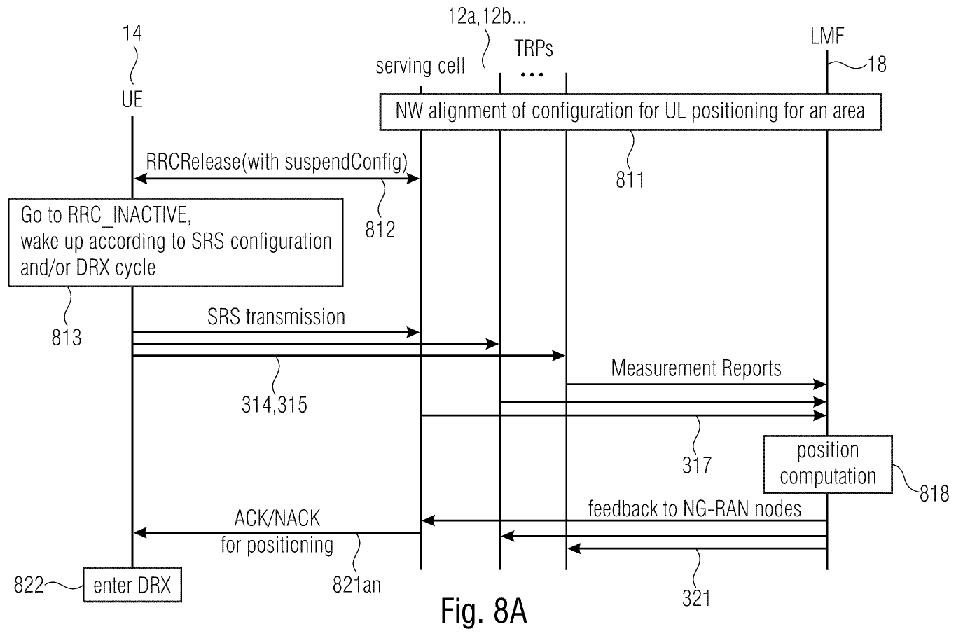

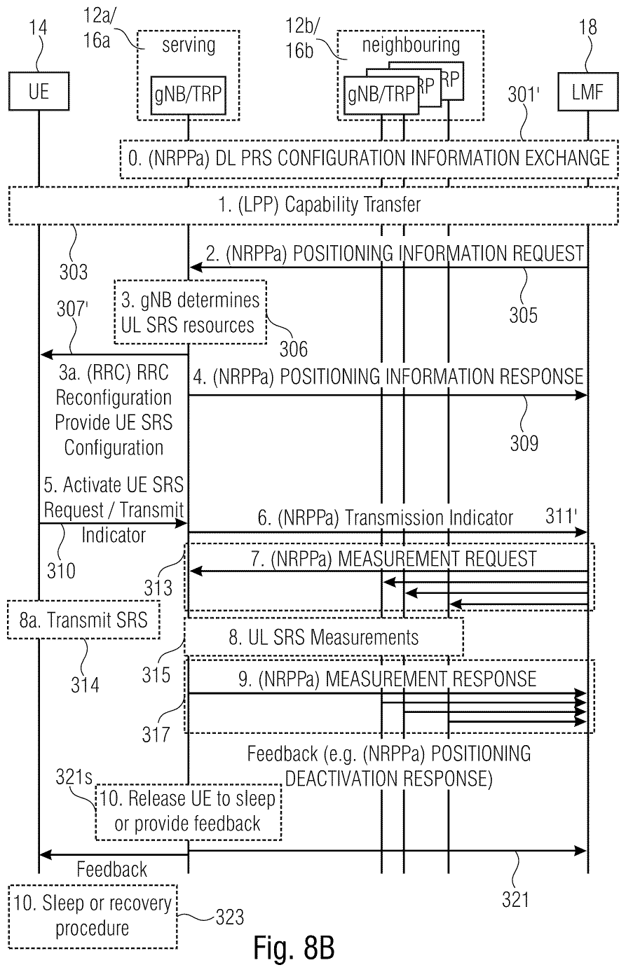

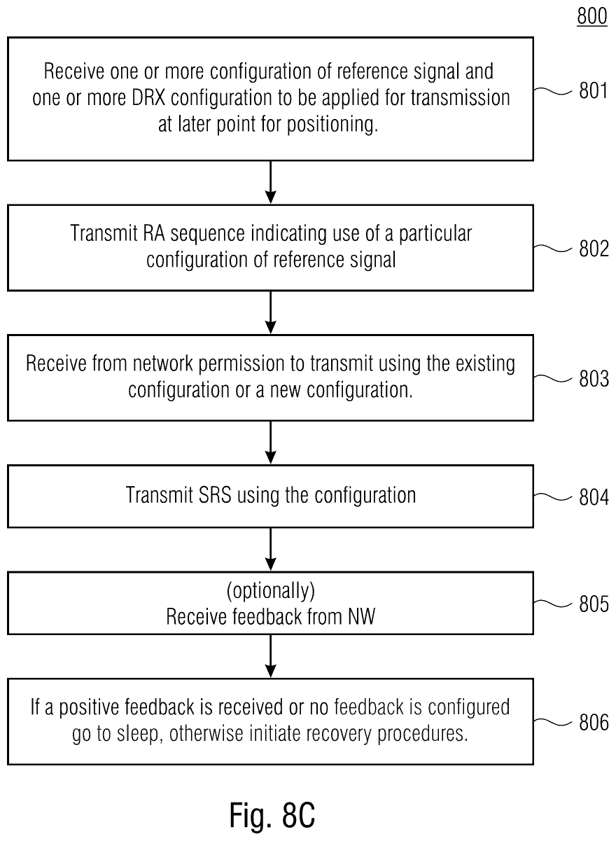

FIG. 8a illustrates a simplified flow diagram depicting elements of signaling for ensuring that positioning of UE is available in event of (extended) DRX cycle. The activities performed by the TRP are marked by TRP1, TRP2 and TRP3, TRP1 is the serving cell. The activities performed by the UE are marked UE, the activities performed by the LMF 18 are marked by LMF 18.

First the TRPs 12a, 16a, 12b, 16b together with the LMF 18 form network alignment of configuration for UL positioning for an area, The network alignment of configuration for UL positioning for an area is performed in the step 811. Based on the same, the configuration are determined and output via RRC release (with suspendConfig), as illustrated by 812.

Then the UE 14 can go to RRC inactive and wake up according to SRS configuration and/or DRX cycle (see 813). When active, the UE 14 transmits the SRS in step 314 and the reception. The TRPs 1, 2 and 3 receive (cf. 12a/16a, 12b/16b) the transmitted SRS signal transmitted by the UE 14 (cf. 315). The measurements are reported in step 317 to the LMF 18 which performs based on the measurement, a position competition 818.

After that a feedback to NG-RAN nodes can be provided (cf. 321). The feedback can indicate to the serving gNB to signal the UE a positive feedback (see 821an) or indicate (see FIG. 8b/321s) the UE 14 to enter the sleep mode in step 323 (cf. FIG. 8b). Whereas, other TRP 12a, 12b/16a, 16b can receive an indication to stop performing measurement on a certain configuration or a set of configurations. The UE can then enter the DRX (i.e. the sleep phase) in step 822 in response to positive feedback (821an) or indication from the network to enter a sleep phase.

FIG. 8b illustrates an enhanced flow diagram depicting elements of signaling for ensuring that positioning of UE is available in event of (extended) DRX cycle.

The illustrated procedure is performed between the entities 18 (LMF), 14 (UE) and the serving/neighboring gNB/TRPs marked by the reference numeral 12a, 12b, 16b.

Some of the steps are identical to the steps discussed in context of FIG. 3, namely the steps 303, 305, 306, 309, 313, 315 and 317. In the step 301′ the DL-PLS configuration information are exchanged between the LMF 18 and the gNB/TRPs 12a, 16a, 12b, 16b. After the step 306 the step 307′ is performed. Here the RRC reconfiguration is done. Here the UE SRS configuration is provided. In response, the UE 14 activates the SRS request and transmits an indicator in the step 310. In response to the step 310 the transmission point/gNB 12a/16a submits the transmission indicator (cf. step 311′).

In parallel to the step 315, the SRS transmission is done as indicated by the step 314. The SRS is transmitted by UE 14. After the transmission 314 and the measurement 315 the measurement response 317 is performed. After that, a feedback 321 from the entity 18 to the entities 12a/16a and 14 can be provided. Here, the entity 12a/16a can release the UE to sleep and provide feedback, so that the entity 14 enters the sleep or recovery procedure in step 323.

According to embodiments, the UE receives from a network entity an SRS configuration to be used for positioning (first configuration) and a DRX cycle (second configuration). The UE transmits the positioning reference signal according to first configuration and taking into account the second configuration. The UE may be further configured to receive a feedback during the active portion of the DRX cycle, wherein the feedback contains information to enable the UE to enter the longer DRX cycle. The feedback may be a trigger or a message from the network contained in any of the following-MAC-CE, RRC message, LPP message or a NAS-DL message.

Regarding the serving cell it should be noted that in one example, the feedback may be sent to the UE directly from the core network entity (e.g. the LMF) using one or more of the protocols (e.g. LPP) terminated between the core network entity (e.g. LMF) and the UE. In case of success, the UE may enter the longer DRX cycle as configured by the NW entity (e.g. the gNB). In case of indication of failure, the UE may initiate recovery procedures. A UE may initiate procedures to enter the RRC_CONNECTED state, so that the UE may be reconfigured by the network to obtain the UE position. A network may provide different first and/or second configuration to the UE. Alternatively, the network may configure the UE to perform and report measurements and/or transmit reference signals so that the network can compute UE position using a different positioning method compared to the first positioning method.

In another embodiment, the RAN node (e.g. the gNB) may receive from the core network entity (e.g. the LMF), a message indicating successful completion or failure of positioning procedure and/or a message to deactivate positioning measurement. The feedback may be carried from the network entity (e.g. LMF) to the NG-RAN node, in one of the protocols terminated between the network entity and the NG-RAN node. In line with this example, the LMF may also configure a NG-RAN node (e.g. a TRP) to perform measurement or report a measurement based on the outcome of measurement made by the TRP on a reference signal or a second reference signal. For example, the LMF may configure one or more TRPs to report measurement on a certain SRS configuration only if it has received the SRS with a certain RSRP. Alternatively, only those TRPs that have received a certain UL reference signal (e.g. PRACH, another SRS, DMRS) having a certain configuration with certain characteristics (e.g. certain RSRP level, certain timing values . . . etc), may need to process and/or perform measurement on an associated SRS configuration. For example, the LMF may signal to the TRP that the TRP needs to measure and/or report SRS Configuration x, only if the measurement on PRACH with configuration y is within a certain RSRP range. (e.g. RSRP >threshold).

As an optional feature, a UE transmits a PRACH/nSRS predefined configuration to indicate its intention to transmit its preconfigured/configured SRS and transmits its preconfigured/configured SRS. By listening to the PRACH, the TRPs are not yet aware of which UE is transmitting, and therefore does not know which configuration of SRS it needs to process yet. When a TRP measures a PRACH signal and if the TRP measures RSRP on PRACH over a threshold, this indicates the TRP (especially the TRPs of neighbouring cells) that some UE is going to transmit the SRS, but it does not know which one (i.e. which configuration). The TRP starts buffering the received signal for a certain window (which may be configured by the LMF or via common-configuration). The window may be derived from the parameters of SRS configuration that are common to a group of UEs within the validity area. On receiving information regarding the configuration of SRS from the LMF, where the configuration or trigger indicates UE specific configuration, which the TRP is expected to process, the TRP then processes the measurement from the buffered samples of radio signals and reports back the measurement to the NW. This way, the UE can transmit PRACH, transmit its configured SRS, indicates the configuration to the network (e.g. serving gNB or LMF) and allow the network to process the buffered samples while the UE goes to sleep. This enables short active time at the UE and may contribute to power saving.

The RAN node (e.g. the gNB) may process the message and signal the UE using one of the protocols terminated between the UE and the gNB, for example, DCI, RRC, or MAC-CE. As an example, the gNB may reconfigure the first configuration and/or the second configuration and/or signal the UE to enter a longer DRX cycle (e.g. by applying a longer DRX cycle).

In some example, the DRX cycle may be configured with small or medium values (for example: configured as subframes or possibly radio frames). Depending upon application, it may be more energy efficient for the network to wait until the next active phase of the DRX cycle, rather than configuring the feedback and taking corrective steps to obtain position.

According to an embodiment, the feedback resource may be used only when the sleep cycle of the DRX cycle is larger than a threshold value signalled by the network. For example, the UE is only expected to listen to feedback resource only if it is entering a sleep cycle larger than a threshold. Alternatively, a UE may be configured with feedback resource only if the sleep cycle is larger than a threshold value.

In line with an example, the UE may be configured with a longer DRX cycle (for example, a DRX cycle having periodicity defined in hyperframes, or in other words minutes) and a shorter DRX cycle (for example, a DRX cycle defined with a periodicity of subframes, or in other words milliseconds). The longer DRX cycle may be configured with the transmission of SRS and the shorter DRX cycle may be configured so that the active phase of the shorter DRX cycle contains the feedback resource.

According to embodiments, a distinction between temporary predictable and non-predictable position requests can be done.

A UE for low power and/or high accuracy positioning may be configured to assist the network with predictable and/or unpredictable instances in time from the network perspective.

Examples of location requests, whose time is predictable in advance could include periodic reporting of MT-LR or scheduled location time feature.

If a UE reselects a cell within a validity area, the SRS configuration is reserved for the UE from the network perspective.

However, in case the UE reselects a cell outside the validity area, the NW does not have information on the configuration and the suitable TRPs that could measure the SRS in advance. Therefore, the NG-RAN node and LMF need to coordinate with one another.

Likewise, event driven location requests could originate at the UE at time instants which are typically not predictable at the network. Event driven location requests could include,
(i) UE availability—for example, when the UE has lost connectivity with the network and the UE is again available.
(ii) Motion of the UE—for example, when the UE has moved from its previous location to a new location, for example, by more than a fixed distance.
(iii) Detection of activity—for example, sensors in wearable devices can identify and characterize motion. Such motion can be used as a trigger for location request. For example, by processing accelerometer measurements or measurements from inertial measurement unit, the motion type can be detected and the location request can be triggered. For example, when the motion sensor within a UE or connected to a UE (e.g. via Bluetooth) indicates a person walking or running.
(iv) Entering a certain area—for example, a UE may be in a certain area within the cellular network. For example, a certain area within the industry floor. Such area may be detected by detection of certain reference signals (e.g. detection of certain SSBs, detection of certain DL-PRS above a certain threshold (e.g. RSRP or timing), etc)
(v) Higher layer trigger
For example, a location request could be triggered by application layer processing of information. For example, detection of a fall, detection of collision, etc.

In case of location requests predictable in advance, the LMF signal the NG-RAN components in advance of an impending transmission. The TRPs can initiate the process of detecting and performing measurements on the signalled configuration. In addition, the configured resources can be reserved for the UE at the serving cell or within the group of cells within the validity area for a given window.

The UE may transmit the SRS according to the configuration provided to the UE if it has been configured with a TA or its last configured TA is valid or if the UE has been provided with configuration or information enabling the UE to select its timing advance itself. The timing advance is validated if the RSRP or timing measurement with respect to a certain downlink reference signal is within a threshold value compared to the previous measurement when the TA was determined, or timing differences and/or RSRP differences between two resources are within a configured value.

In case of location requests occurring at time and/or location not previously known to the network in advance, then the UE may initiate a random access procedure to enable the network entity (e.g. the gNB) to determine the TA for the SRS to be transmitted and/or to signal the network that the UE is expecting to transmit the SRS in next occasion. The UE may indicate the configuration of the SRS it intends to use to its serving gNB. The UE may either request transmission of the SRS using the identifier indicating the configuration the UE intends to use and/or the UE may indicate certain parameters that it intends to use for transmission. The information may be transmitted as MSG-3 or MSG-A as a RRC message. Furthermore, a UE may be configured with one or more configurations, wherein the UE indicates to the network entity (e.g. the gNB), the preferred configuration it intends to use for transmission out of a set of configuration provided to the UE.

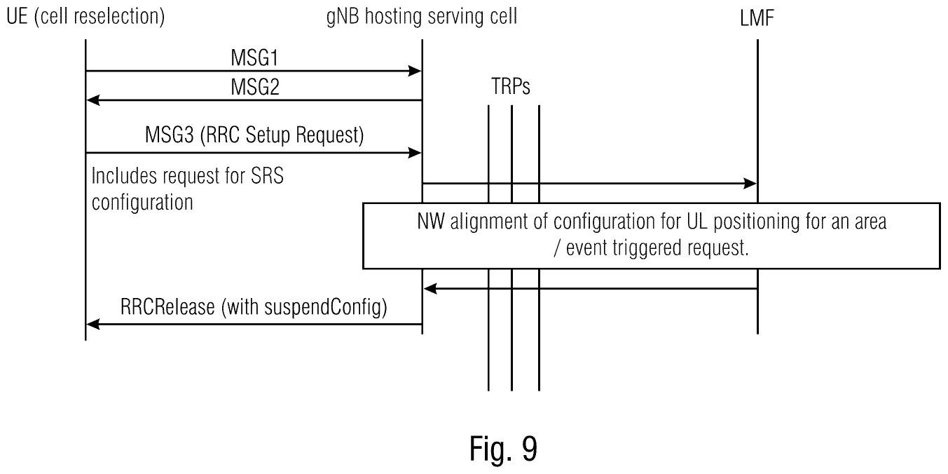

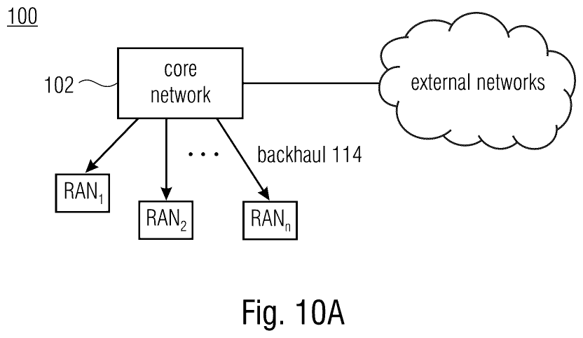

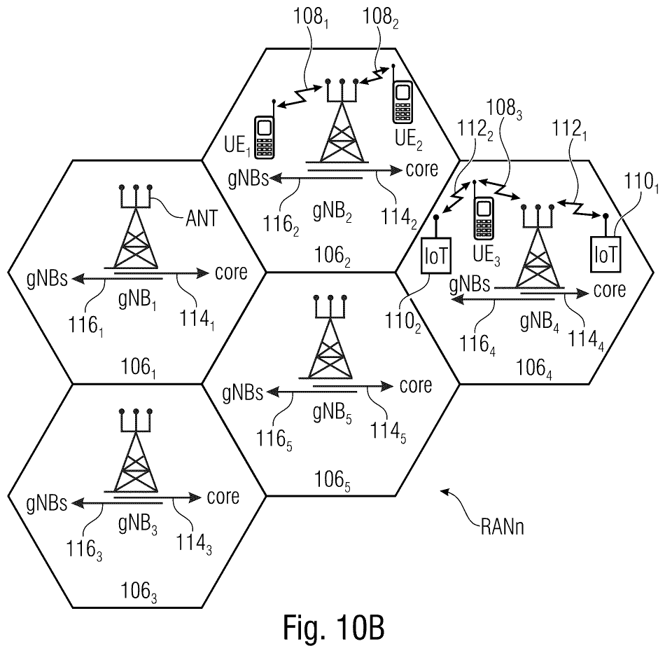

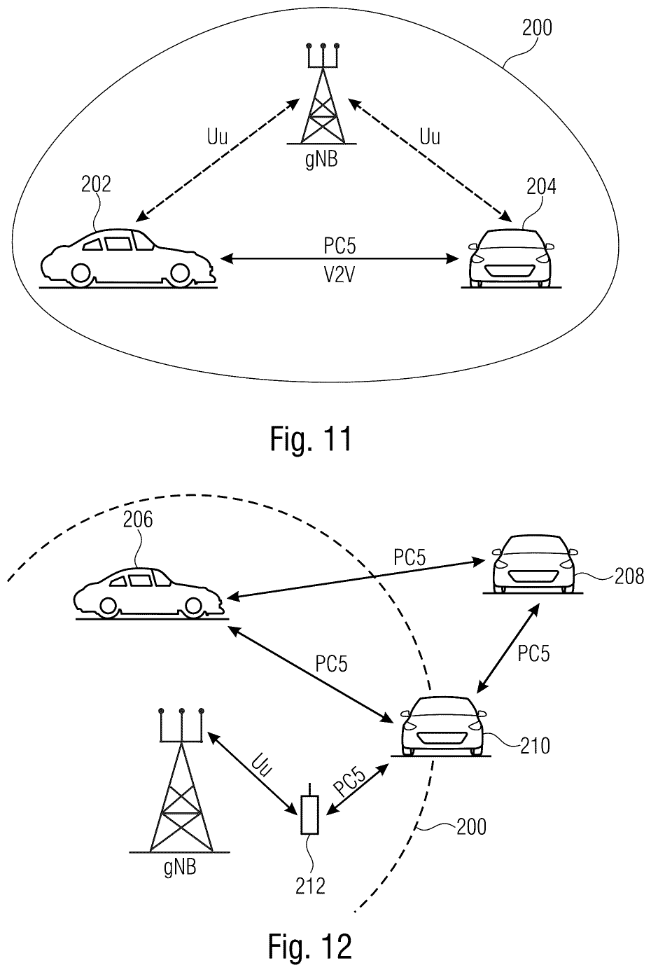

FIG. 9 shows the communication between the UE and the gNB hosting the serving cell. Here messages are output to exchange the configuration, so as to perform network alignment of configuration for UL positioning for an area/event to get requested. In particular, the serving cell may signal the network, where the signalling message indicates the LMF that the UE indicated in this signalling message or a group of UEs intend to transmit. The LMF may then determine the set of TRPs and configure the TRPs to perform the measurement on the configuration transmitted by the indicated UE. Likewise, the TRPs may already have been indicated the configuration, in which case, the LMF may simply indicate the TRPs to perform the measurement.

On the other hand, the network may determine that the configuration provided to the UE may need to be updated, in which case, the network entity (gNB) will provide updated configuration to the UE. The updated configuration may be negotiated between one or more NW entities (e.g. TRPs or LMFs) before providing to the UE. In one example, the updated configuration may be provided in the suspendConfig. Alternatively, the UE may be provided this configuration by dedicated RRC or LPP message.

The configuration of the resource used for positioning used in one or more than one cells within the validity area may be identified using a combination of two or more of the following: area ID, identifier for the resource set ID, and identifier for the resource ID. Alternatively, the configuration may be identified by an identifier provided by the network, which is uniquely identifiable within the validity area and/or within the RNA.

The configuration may be applicable to a single UE or a group of UEs. When the UE initiates the RA procedures to request to transmit using a certain configuration of resource, the UE may indicate its preferred configuration and may optionally indicate values of one or more parameters it intends to use. The parameter and/or configuration the UE intends to use may be indicated to the serving cell by including the information within the MSG-3 or MSG-A of the random access procedure.

The network entity may provide the grant within MSG-4 or MSG-B of the random access procedure. The grant may indicate a confirmation to the UE to use a certain configuration or the network may indicate the UE to use a different configuration from the set of preconfiguration to the UE. Alternatively, the NW may indicate configuration identifier and/or parameter and its value to be updated to the UE. Alternatively, the NW may include a new configuration inside the suspendConfig IE.

According to an embodiment, when the RA is sent to the serving cell, the serving cell triggers the LMF to trigger the other gNBs participating in measurement of the UL reference signal for the UE. The other gNBs send a positive acknowledgement to the LMF and the LMF sends a trigger to the serving gNB. The serving gNB then sends the MSG-B or MSG-3 indicating the grant to the UE. Within the grant from the network to the UE to transmit a message, the network could include and/or update the configuration for the feedback resource. For example, the feedback resource could be indicated with an offset with respect to a certain SRS transmission occasion, such as 10 slots after the first SRS transmission. Alternatively, the feedback resource could be indicated to the UE to occur within a window. Furthermore, the network may indicate the default behaviour, e.g. no feedback received within a window is interpreted as positioning failure, and the UE shall trigger connection with the network.

The feedback within the feedback window could be an acknowledgment of successful transmission enabling the UE to enter the sleep phase.

Alternatively, within the feedback window, the UE may receive an RRC message from the network indicating the UE to transmit SRS with a different configuration or retransmit SRS with the current configuration in case of failure.

In line with an example, the LMF may interact with one or more network functions (e.g. the UDM) to identify the UE is a low power high accuracy positioning device. Furthermore, it may interact with the serving gNB and/or one or more NW functions to determine suitable positioning parameters, such as (e)-DRX period, periodicity of required SRS and so on and request them from the serving gNB. It may indicate the gNB, that the UE may go into sleep mode only after positive confirmation.

A UE may perform measurement on one or more downlink reference signal, and based on the downlink reference signal, the UE may do one of the following:
1) Transmit the SRS using one of the configuration
2) Initiate the RA procedure with the camped cell, wherein within the MSA-A or MSG-3, the UE indicates the SRS configuration it intends to transmit. The serving gNB may indicate the intended configuration to LMF and/or other NG-RAN nodes, and may confirm the configuration or provide an alternate configuration.
3) Send an on-demand PRS request, for a certain second configuration of DL-PRS signals and/or certain uplink SRS configuration.
4) Indicate to the network the measurement or report the K, where K>=1, downlink reference signals that are best suited according to some criteria. The downlink reference signals may be SSBs that the UE is configured to measure, and the measurement of DL-RS may indicate the network node the most suitable SRS configuration to use for the given measurement. The gNB may provide a configuration to the UE to use for transmission, using the suspendConfig.

According to embodiments, the feedback information may be carried, using mobile terminated small data transmission mechanism.

According to further embodiments,, a UE may be configured with a particular configuration from the set of first configurations provided to the UE, wherein the wherein a specific first configuration from a set of first configurations signals the network that the transmission is UEs last positioning signal (last positioning signal indication) or the UE indicates that the message is the last message before the UE goes to sleep (for example, using the configured resources where the UE is allowed to transmit signalling data, for example using the mobile originated small data transmission mechanism).

In line with this embodiment the user equipment may receive the feedback resource after transmitting signal after sending last positioning signal indication and/or a last message or last message indication, wherein responsive to receiving the positive feedback, the UE enters the sleep mode and wherein responsive to receiving a negative feedback, the UE initiates the recovery procedures.

The above description of the embodiments was mainly made from the point of view of the UE. According to further embodiments the transmission point or, in general, the network entity/or another UE in case of sidelink communication may be configured for the following
to provide one or more first configurations to an user equipment, the one or more first configurations comprising parameters for a reference signal to be transmitted by the user equipment during a particular RRC state (e.g. RRC_INACTIVE) to enable position determination;
to provide a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging); so that the user equipment is enabled to transmit the reference signal according to one of the one or more first configuration and/or taking into account one of the one or more second configurations (defining the DRX cycle).

According to embodiments, the transceiver of the network entity/transmission point/another UE may be configured to communicate with a UE which is configured to transmit a reference signal during an active phase of a UE activity cycle (DRX cycle or eDRX cycle) wherein the transceiver is configured to output a one or more first configurations and one or more second configurations including validity information or a validity information to the UE, wherein the configuration of the UE is valid for a validity area or wherein a UE is allowed to communicate in accordance to the validity information.

According to embodiments the validity information indicates one or more sound/areas to be valid. According to embodiments, the transceiver is configured to provide a reference signal configuration as part of the configuration.

Another embodiment refers to a network entity, e.g., a TRP comprising a transceiver which is configured to output a feedback with a feedback within feedback window and/or using feedback resources, wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

According to embodiments, the transceiver is configured to provide an RRC message within a feedback window indicating the UE to transmit a reference signal with a different configuration or retransmit a reference signal with the current configuration in case of a failure.

According to embodiments, the transceiver is configured to output a predictable or non-predictable request or information on an event, e.g. UE available, motion of UE, detection of activity, entering a certain area, higher layer trigger, being outside of validity area.

According to embodiments, a location request is predictable in advance, if the LMF signal the NG-RAN components in advance of an impending transmission so as initiated a process of position determination and performing measurement; and/or wherein the transceiver outputs a configuration including configured resources being reserved for the UE at the serving cell or within a group of cells within the validity area for a feedback window.

According to embodiments, the transceiver is configured to output a location request occurring at time and/or location not previously known to the network in advance, wherein the UE is configured to initiate a random access procedure to enable the TRP or another UE to determine the TA for the reference signal to be transmitted and/or to signal the network that the UE is expecting to transmit the reference signal in next occasion.

According to embodiments, the configuration of the resource(s) used for positioning used in one or more cells within the validity area are identified using a combination of two or more of the following:
area identifier:
identifier for the resource set ID:
identifier for the resource ID:
identifier provided by the network:
unique identifier for the validity area and/or within the RNA.

According to embodiments, the configuration is differentiated for an active phase or sleep phase of the UE; and/or wherein the configuration comprises parameters controlling the sleep phase of the UE; and/or wherein a suspend configuration of the configuration contains information about feedback resource(s).

According to embodiments, the transceiver is configured to provide a configuration applicable to a single UE or a group of UEs; and/or wherein the transceiver is configured to provide a grant within MSG-4 or MSG-B of the random access procedure.

According to embodiments, the grant is transmitted using a message including configuration for feedback resources or update configuration for feedback resources.

According to embodiments, the network entity is configured to output a feedback on the reference signal or the signaling message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

According to embodiments, the network entity is configured to initiate an NG-RAN not indicating to the UE on the feedback resource that position determination has been completed in response to the message containing indication of successful positioning operation; and/or to forward the feedback to a TRP to be transmitted to the UE; and/or to output feedback to the UE so that the UE may enter a sleep phase of a (DRX) cycle.

According to embodiments, the network entity is configured to interact with one or more NW entity (e.g. UDM, NEF, GMLC) and exchanging information about the UE (e.g. subscription, provisioning, policy, charging, analytics, expected movement, behavior) and/or information about the RAN-network (e.g. OAM, NG-RAN nodes) so as to determine the configuration to be provided to the UE and its validity area. It, for example collects measurements from one or more TRP, and/or to compute position, and/or determine if the position is successful and to send positive feedback to the UE.

According to embodiments, the network entity is configured to
receive a RA request from a UE wherein the UE requesting to use a particular configuration or requests a NW configuration;
to indicate to a second NW (TRP, gNB) entity to perform measurement and/or signals the third entity (LMF) to instruct a second NW entity (TRP, gNB) to perform measurement; and/or
to provides or indicate the configuration used by the UE, which may further indicate the expected window where the reference signal is expected.

Here, at least one second NW entity is associated with the validity area of the configuration used by the UE.

According to embodiments, the network entity is configured to receive information from an application function (AF) and/or UE profile and/or UE subscription on a threshold value beyond which the network entity (e.g. LMF/gNB) configures a feedback resource for the UE. In other word, this ensures that the position is available before the UE becomes unreachable by paging for a specified time. This might be important for the situation where the NW entity itself receives information from external source or UE subscription data, and determines what is the threshold value where the UE can go to sleep without having to ensure that position is available. Note, through the network exposure function (NEF), an external application can influence the NW behavior.

According to embodiments, the network entity (e.g. LMF) is configured to receive information from an application function (AF) and/or UE profile and/or UE subscription about the characteristics of UE activity on expected location requested events.

According to embodiments, the network entity (e.g. TRP) is configured to receive information from a second network entity (e.g. the LMF) information on time window where the UE is expected to wake up and transmit positioning reference signals according to configuration. For example, a UE may be configured to transmit SRS every 30 seconds, but there may be an uncertainty that the UE may transmit the SRS within +/−1 seconds). Then the NW entity (e.g. the TRP) may be configured with an window described by a certain time (e.g. periodicity, offset, system frame number, radio frame number, hyper frame number) and certain uncertaintly) and an uncertainty (e.g. duration, offset, system frame number, radio frame number, hyper frame number) and certain uncertaintly). During the configured window, the TRP is configured to perform measurement and report on measurement. In contrast to periodically scheduled SRS transmission, such event triggered location request may have larger periodicity and uncertaintly. The TRPs may further be configured to report measurement conditioned on certain information or assistance data or measurements.

Another embodiment refers a communication system comprising a UE and a TRP and/or a network entity like an LMF.

The above embodiments have mainly been discussed in context of an apparatus, e.g. a UE or TRP. According to further embodiments, corresponding methods are provided, namely a method for operating a UE, a method for operating a network entity in terms of a TRP and a method for operating a network entity in terms of an LMF.

FIG. 8c shows schematically a possible process for an embodiment using the received configurations to configure the sleep behavior.

The method comprises the steps 801 of receiving one or more configuration of a reference signal and one or more DRX configuration. After that, the RA sequence is transmitted in the step 802 and received from network permissions in step 803. In the following, the SRS signal is transmitted using the configuration in step 804 when optionally the feedback from the network is received in step 805. The step 806 refers to the feedback.

The method for operating a UE may comprise the following steps:
receiving one or more first configurations from a network entity (e.g. TRP or LMF) of the wireless network, the one or more first configurations comprising parameters for a reference signal to be transmitted by the user equipment during a particular RRC state (e.g. RRC_INACTIVE) to enable position determination;
receiving a one or more second configurations from the network entity (e.g. the gNB), the one or more second configuration comprising parameters describing an active phase and an sleep phase of an UE activity cycle (e.g. DRX cycle or an
   eDRX cycle), wherein during the active phase the user equipment is configured to receive one or more signaling messages from a network entity, and wherein during the
   sleep phase, the UE is temporarily unreachable (e.g. by paging);
transmitting the reference signal according to one of the one or more first configuration and/or taking into account one of the one or more second configurations (defining the DRX cycle).

A method for operating a network entity/TRP may comprise the following steps
communicating with a UE which is configured to transmit a reference signal and/or to signal a message for a measurement during an active phase of a (DRX) cycle;
outputting a configuration including a validity information or a validity information to the UE, wherein the configuration of the UE is valid for a validity area or wherein the UE is allowed to communicate in accordance to the validity information.

A method for operating a network entity/TRP may alternatively comprise the steps of
providing one or more first configurations to an user equipment, the one or more first configurations comprising parameters for a reference signal to be transmitted by the user equipment during a particular RRC state (e.g. RRC_INACTIVE) to enable position determination;
providing a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging); so that the user equipment is enabled to transmit the reference signal according to one of the one or more first configuration and/or taking into account one of the one or more second configurations (defining the DRX cycle).

A method for operating a network entity like an LMF may comprise the following steps
performing a measurement or position determination based on an information on a received reference or received signaling message from a UE or based on a reference signal or message received from the UE;
outputting a feedback on the reference signal or the message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

Embodiments of the present invention have been described in detail above, and the respective embodiments and aspects may be implemented individually or two or more of the embodiments or aspects may be implemented in combination.

(Please capture the embodiments for sidelink too: please capture particularly the following: * In sidelink, the anchor UEs may additionally take the TRP roles described in the document in in-coverage and partial coverage scenario, and take the role of TRP in out-of-coverage scenario. Furthermore, the server UE may take the LMF role in out of coverage scenario. The embodiment described here apply analogously to the sidelink scenario. The UE in above description may also correspond to the roles of target UE in sidelink. A UE in sidelink may take one or more roles within the same positioning session (e.g. target and server at the same time) or different session (e.g. target in one session and anchor in other) or context.)

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

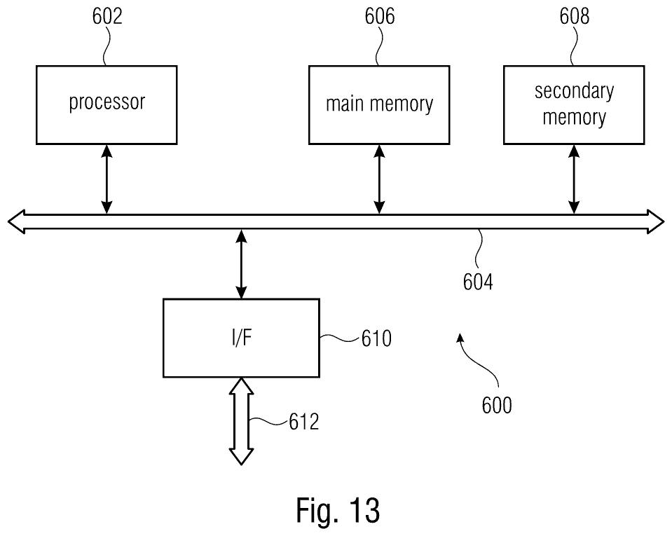

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. User equipment, UE, in wireless network, the user equipment comprising a transceiver, where the transceiver is configured:
to receive one or more first configurations from a network entity (e.g. TRP or LMF) of the wireless network, the one or more first configurations comprising parameters for a reference signal to be transmitted by the user equipment;
to receive a one or more second configurations from the network entity (e.g. gNB), the one or more second configuration comprising parameters describing an active phase and an sleep phase of an UE activity cycle (e.g. DRX cycle or an eDRX cycle), wherein during the active phase the user equipment is configured to receive one or more signaling messages from the network entity, and wherein during the sleep phase, the UE is temporarily unreachable (e.g. by paging);
to transmit the reference signal according to one of the one or more first configuration and taking into account one of the one or more second configurations (defining the DRX cycle).

2. User equipment according to claim 1, wherein the user equipment selects the one first configuration from the one or more first configurations and/or the one second configuration from the one or more second configurations according to a selection criterion or a selection criterion signaled to the user equipment.

3. User equipment according to claim 2, where the selection criterion is based on at least one of the following:
validity area (configured to the UE);
validity time (configured to the UE)
event or type of the event (e.g. triggered by higher layers in a protocol stack of the UE);
periodicity of positioning
timing advance and/or predictability, especially whether or not timing advance can be determined by the UE or the previously determined timing advance can be validated by the UE;
whether the UE is allowed by a network to operate in MICO mode;
the Radio resource control, RRC, state of the UE

4. User equipment according to claim 1, where the reference signal transmitted by the UE is a sounding reference signal for positioning purposes and/or wherein the RRC state is a RRC_INACTIVE state.

5. User equipment according to claim 1, wherein the UE is configured with at least one feedback resource, which the transceiver is configured to monitor to receive feedback from at least one network entity; or
wherein the UE is configured with at least one feedback resource, which the transceiver is configured to monitor to receive feedback from at least one network entity and wherein the feedback indicates whether or not a positioning procedure has successfully completed and/or a measurement made by at least one TRP meets a needed quality.

6. User equipment according to claim 5, wherein the feedback resource comprises of a configured resource or a group of resources within a configured window, wherein the user equipment is configured to take an action depending on the type of feedback received during the feedback resource.

7. User equipment according to claim 1, wherein the user equipment is configured to enter a sleep state if a positive feedback is received during the feedback resource, and/or
wherein the UE is configured to initiate one or more recovery procedures to enable the network entity to determine an UEs position; and/or
where the transceiver is configured to transmit the reference signal during the active phase of the UE activity cycle and to enter the sleep phase of the UE activity cycle dependent on a sleep criterion.

8. User equipment according to claim 7, wherein the sleep criterion is fulfilled, when a feedback is received or when a feedback is received and the feedback is a positive feedback.

9. User equipment according to claim 8, wherein the feedback indicates one of the following:
incorrect or correct receipt of the reference signal and/or a message at the TRP or another UE, e.g. using ACK/NACK;
incorrect or correct receipt of the reference signal and/or the message at the TRP or another UE and insufficient or sufficient information to be extracted from the reference signal and/or the message to perform a measurement or position determination;
insufficient or sufficient information to be extracted by the LMF from the reference signal and/or the messaging to perform a measurement or position determination;
failed or successful measurement or position determination performed by the LMF
or wherein a positive feedback indicating one of the following:
correct receipt of the reference signal and/or the message at the TRP or another UE, e.g. using ACK/NACK;
correct receipt of the reference signal and/or the message at the TRP or another UE and sufficient information to be extracted from the reference signal and/or the message to perform a measurement or position determination;
sufficient information to be extracted by the LMF from the reference signal and/or the messaging to perform a measurement or position determination;
successful measurement or position determination performed by the LMF.

10. User equipment according to claim 8, wherein the feedback may be any one of a following type:
an implicit positive feedback, wherein no feedback received by the UE is considered positive feedback;
an implicit negative feedback, wherein no feedback received by the UE indicates a negative feedback;
an explicit positive and an explicit negative feedback, wherein no feedback received by the UE triggers a fallback procedure;
an indication to transmit reference signal with a configuration different to the first configuration selected by the UE, by providing an identifier indicating one of the configuration, or one configuration from a group of configurations, or by providing a new configuration;
an indication to change parameters describing the DRX cycle, such as DRX period, active part of a cycle, sleep portion of the cycle, etc.

11. User equipment according to claim 1, wherein a first configuration of reference signal transmitted by the UE is a PRACH signal and a feedback contains a configuration of reference signal or an indication to a particular configuration of reference signal preconfigured to the UE, wherein UE transmits using the configuration provided in the feedback for positioning.

12. User equipment according to claim 11, where the configuration of the positioning reference signal to be transmitted in RRC_INACTIVE state is carried by the MSG-B or MSG-4 of the random access procedure.

13. User equipment according to claim 8, wherein the transceiver is configured to listen for the feedback or listen for a feedback via a feedback resource and/or during an feedback window.

14. User equipment according to claim 8, wherein the feedback resource occurs in time after transmitting.

15. User equipment according to claim 6, wherein the feedback resource is only used, when the sleep phase of the, DRX, cycle is larger than a threshold value signaled by the network; and/or
wherein the, DRX, cycle may be a small or medium or large, DRX, cycle and
wherein the feedback resource are only used, for a large, DRX, cycle.

16. User equipment according to claim 6, wherein feedback resources are one or more out of the group comprising:
configured resources in downlink and/or sidelink (e.g. PSSCH) wherein RRC message and/or LPP and/or SLPP and/or NAS-DL message is included by the configured resources;
MAC-CE transmitted from the gNB to the UE or downlink;
MAC-CE transmitted using small data transmission mechanism;
the one or more first configurations of resources indicating time-frequency location for on-demand reference signal;
resources associated to the one or more first configurations belonging to the reference signal;
configuration of a DL-PRS resource, which is transmitted on-demand from a network entity (e.g. in response of certain events, such as successful reception of a position resource).

17. User equipment according to claim 1, wherein the transceiver is configured to perform the transmission taking into account a validity area information or a validity area information included by the one or more first configurations or only if the UE is arranged within a valid area according to a validity area information.

18. User equipment according to claim 1, wherein the sleep phase comprises an inactive or an idle state of the transceiver.

19. User equipment according to claim 5, wherein the, DRX, cycle is a short, DRX, cycle or long, DRX, cycle, wherein the long, DRX, cycle is configured with the transmission of the one or more first configurations and wherein the short, DRX, cycle is configured, so that the active phase contains a feedback resource; and/or
wherein the, DRX, cycle is a short, DRX, cycle or a long, DRX, cycle comprising a short, DRX, cycle, wherein the short cycle ends if the feedback resource has a positive acknowledgement so that the UE goes into sleep according to a sleep cycle of a long DRX cycle or wherein UE wakes up according to short cycle to monitor the feedback resource and/or transmit the reference signal until the positive feedback is received or until timeout.

20. User equipment according to claim 1, wherein the transceiver is configured to interact with a TRP, LMF or network for performing position determination if the transceiver receives the negative feedback, NACK, or implicitly receives the negative feedback or to perform a recovery procedure.

21. User equipment according to claim 7, wherein the recovery procedure comprises one of the following:
entering RRC connected state and/or CM connected state so as to enable the network to initial a new position procedure with the UE (e.g. determining a UE position with alternative position methods, such as using multi-RTT);
requesting the network to use a different first configuration from a set of one or more first configurations or preconfigured one or more first configurations,
selection of a configuration (different to the one originally selected) from the set of one or more configurations provided to the UE, and transmitting the reference signal according the newly selected configuration;
selection of a configuration (different to the one originally selected) from the set of one or more configurations provided to the UE, and indicating to the network entity the configuration used by the UE;
selection of a configuration (different to the one originally selected) from the set of one or more configurations provided to the UE, and requesting the network entity to grant the configuration selected by the UE;
retransmission of a signal.

22. User equipment according to claim 1, wherein the transceiver is configured to transmit according to one or more first and/or second configurations or to transmit according to provided one or more first and/or second configurations being valid within an area such as a group of cells.

23. User equipment according to claim 1, wherein the one or more first and/or second configurations are provided by the network, the TRP or preconfigured.

24. User equipment according to claim 1, wherein the one or more first and/or second configurations comprises time and frequency allocation and/or parameters determining lengths of sequence(s) and/or sequence(s) used for transmitting the reference signal.

25. User equipment according to claim 1, wherein the one or more first and/or second configurations comprises one or more of the following parameters:
identifiers to identify the particular configuration unique among a set of the first and/or second configurations available to the UE, if the UE is provided with more than one configuration:
srs-PosRresourceSetID;
srs-PosResourceSetID;
transmissionComb;
transmissionCombOffset;
resourceMapping;
freqDomainShift;
freqHopping;
groupOrSequenceHopping;
resourceType.

26. User equipment according to claim 1, wherein the UE is configured to receive the configuration or reference signal configuration while the UE is in a certain RRC state or in one of certain RRC states.

27. User equipment according to claim 1, wherein the one or more first and/or second configurations are differentiated for an active phase or sleep phase; and/or
wherein the one or more first and/or second configurations comprises parameters controlling the sleep phase; and/or
wherein a suspend configuration of the configuration contains information about feedback resource(s).

28. User equipment according to claim 1, wherein the one or more first and/or second configurations are mapped to one or more areas/cells.

29. User equipment according to claim 1, wherein the one or more first and/or second configurations comprise multiple configurations (e.g. associated with certain type of location requests).

30. User equipment according to claim 1, wherein each of the one or more first and/or second configurations is valid for one or more areas or cells or valid beyond a cell; and/or
wherein each of the one or more first and/or second configurations includes information on validity (e.g. validity area may be signaled as a group of cells on same carrier bandwidth).

31. User equipment according to claim 5, wherein the feedback resource is associated with the one or more first configurations.

32. User equipment according to claim 1, wherein the transceiver is configured to transmit in accordance to a validity area information, wherein the validity area information comprises one of the following:
a group of cells on the same carrier bandwidth;
a RAN notification area and/or tracking area;
a system information area;
a cell;
a certain part or portion of a cell, or a certain part or portion of a RAN notification area, or a part or a certain portion of the system information area or a part or a portion of a position system information area, each being donated by an appropriate area identifier;
certain parts or portion of at least two cells;
V2X Zone;
geographical area described by a geometric area descriptior, GAD;
area, where the UE within the area is handled by a certain network entity, e.g. within the group of cells hosted by a GNB or network equipment.

33. User equipment according to claim 6, wherein the transceiver is configured to enter a sleep phase for a short, DRX, cycle after transmitting and before expecting feedback.

34. User equipment according to claim 1, wherein the user equipment is configured to perform cell reselection; and/or
wherein the user equipment is configured to perform cell reselection within one of cells.

35. User equipment according to claim 33, wherein UE is configured to perform validation of timing advance, especially a previously determined timing advance and/or to update the timing advance autonomously; or
wherein UE is configured to perform validation of TA and/or to update the timing advance autonomously, wherein the UE continues to transmit using a known configuration if the TA can be validated and/or wherein the UE performs random access procedure if the TA cannot be validated; or
wherein UE is configured to perform validation of timing advance and if the UE is provided with valid configuration the UE reselects the cell and/or continue transmission; and/or
wherein the UE is configured to initiate a random access procedure to enable the network entity to determine the TA.

36. User equipment according to claim 33, wherein the UE is configured to start transmitting SRS transmission and/or to perform random access procedure to acquire timing advance if a UE performs cell-reselection in one of the cells within a validity area and/or wherein the UE is configured to indicate the network to activate a first configuration if a UE performs cell-reselection; and/or
wherein the UE is configured to perform cell reselection within a validity area and to indicate a transmission which has not be scheduled by the network or to signal the NW to prepare for transmission.

37. User equipment according to claim 33, wherein the UE is configured to stop an ongoing transmission and/or to request a new configuration of SRS and/or to indicate to a RAN-node if the UE performs cell-reselection in one of the cells outside the validity area; and/or
wherein the UE is configured to reselects a cell outside the validity area and/or upon cell reselection, the UE is configured to release its existing SRS configuration and acquire a new configuration from the new cell and/or wherein the UE does not continue transmitting positioning reference signals if the UE performs cell-reselection.

38. User equipment according to claim 33, wherein a timing advance is validated if the RSRP or timing measurement with respect to a certain downlink reference signal is within a threshold value compared to the previous measurement, or timing differences and/or RSRP differences between two resources are within a configured value; and/or
wherein a stored RSRP is updated when the UE performs one out of the following:
obtaining at least one first configuration valid in the area where the UE is camped;
obtaining a timing advance command from the network;
adjusting the timing advance autonomously subject to UE capabilities.

39. User equipment according to claim 1, wherein the reference signal is output based on location request, predictable request (e.g. scheduled location time or deferred MT-LR), or non-predictable request or event driven, e.g. UE available, motion of UE, detection of activity, entering a certain area, higher layer trigger, being outside of the validity area.

40. User equipment according to claim 1, wherein the transceiver is configured to transmit the reference signal according to the one or more first configurations, if it has been configured with a TA or its last configured TA is valid or if the UE has been provided with the one or more first configurations or information enabling the UE to select its timing advance.

41. User equipment according to claim 1, wherein the transceiver is configured to transmit the reference signal according to the one or more first configurations, if it has been configured with a spatial relation indicating to the UE to use a certain UE beam for transmitting.

42. User equipment according to claim 1, wherein the transceiver is configured to transmit the reference signal according to one or more first configuration, wherein a specific first configuration from a set of first configurations signals the network that the transmission is UEs last positioning signal (last positioning signal indication) or last message before the UE goes to sleep.

43. User equipment according to claim 1, wherein the UE receives the feedback resource after transmitting signal after sending last positioning signal indication and/or a last message, wherein responsive to receiving the positive feedback, the UE enters a sleep mode and wherein responsive to receiving a negative feedback, the UE initiates the recovery procedures.

44. Network entity or transmission point, TRP, or another UE comprising a transceiver configured to
to provide one or more first configurations to an user equipment, the one or more first configurations comprising parameters for a reference signal to be transmitted by the user equipment for position determination;
to provide a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging); so that the user equipment is enabled to transmit the reference signal according to one of the one or more first configuration and taking into account one of the one or more second configurations (defining the DRX cycle).

45. Network entity or transmission point, TRP, or another UE comprising a transceiver configured to communicate with a UE which is configured to transmit and/or a reference signal during an active phase of an UE activity cycle (e.g. DRX cycle or an eDRX cycle);
wherein the transceiver is configured to output a one or more first configurations and one or more second configurations including a validity information or the validity information to the UE, wherein a configuration of the UE is valid for a validity area or wherein the UE is allowed to communicate in accordance to the validity information.

46. Network entity or transmission point, TRP, or another UE according to claim 44, wherein the validity information indicates one or more cells/area where the first and/or the second configuration are valid selection for the UE.

47. Network entity or transmission point, TRP, or another UE according to claim 44, wherein the transceiver is configured to provide a reference signal configuration as part of the configuration; and/or
wherein the transceiver is configured to provide a reference signal configuration as part of the configuration.

48. Network entity or transmission point, TRP, or another UE according to claim 44, wherein the transceiver is configured to output a feedback within a feedback window and/or using feedback resources, the feedback indicating one of the following:
incorrect or correct receipt of the reference signal and/or a message at a TRP or another UE, e.g. using ACK/NACK;
incorrect or correct receipt of the reference signal and/or the message at the TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

49. Network entity or transmission point, TRP, or another UE according to claim 44, wherein the transceiver is configured to provide an RRC message within the feedback window indicating the UE to transmit a reference signal with a different configuration or retransmit a reference signal with the current configuration in case of a failure.

50. Network entity or transmission point, TRP, or another UE according to claim 44, wherein the transceiver is configured to output a predictable or non-predictable request or information on an event, e.g. UE available, motion of UE, detection of activity, entering a certain area, higher layer trigger, being outside of validity area.

51. Network entity or transmission point, TRP, or another UE according to claim 44, wherein a location request is predictable in advance, if the LMF signal the NG-RAN components in advance of an impending transmission so as initiated a process of position determination and performing measurement; and/or
wherein the transceiver outputs a configuration including configured resources being reserved for the UE at the serving cell or within a group of cells within the validity area for the feedback window.

52. Network entity or transmission point, TRP, or another UE according to claim 44, wherein the transceiver is configured to output a location request occurring at time and/or location not previously known to the network in advance, wherein the UE is configured to initiate a random access procedure to enable the TRP or another UE to determine the TA for the reference signal to be transmitted and/or to signal the network that the UE is expecting to transmit the reference signal in next occasion.

53. Network entity or transmission point, TRP, or another UE according to claim 44, wherein the configuration of the resource(s) used for positioning used in one or more cells within the validity area are identified using a combination of two or more of the following:
area identifier;
identifier for the resource set ID;
identifier for the resource ID;
identifier provided by the network;
unique identifier for the validity area and/or within the RNA.

54. Network entity or transmission point, TRP, or another UE according to claim 44,
wherein the configuration is differentiated for an active phase or sleep phase of the UE; and/or
wherein the configuration comprises parameters controlling the sleep phase of the UE; and/or
wherein a suspend configuration of the configuration contains information about feedback resource(s).

55. Network entity or transmission point, TRP, or another UE according to claim 44, wherein the transceiver is configured to provide a configuration applicable to a single UE or a group of UEs; and/or
wherein the transceiver is configured to provide a grant within MSG-4 or MSG-B of the random access procedure.

56. Network entity or transmission point, TRP, or another UE according to claim 55, wherein the grant is transmitted using a message including configuration for feedback resources or update configuration for feedback resources.

57. Network entity or LMF configured to perform a measurement or position determination based on an information on a received reference or received signaling message from a UE or based on the reference signal or signaling message received from the UE; wherein the network entity is configured to output a feedback on the reference signal or the signaling message; wherein the feedback indicates one of the following:
incorrect or correct receipt of the reference signal and/or the message at a TRP or another UE, e.g. using ACK/NACK;
incorrect or correct receipt of the reference signal and/or the message at a TRP or another UE and insufficient or sufficient information to be extracted from the reference signal and/or the message to perform a measurement or position determination;
insufficient or sufficient information to be extracted by a LMF from the reference signal and/or the messaging to perform a measurement or position determination;
failed or successful measurement or position determination performed by a LMF.

58. Network entity according to claim 57, wherein the network entity is configured to initiate an NG-RAN not indicating to the UE on a feedback resource that position determination has been completed in response to a message containing indication of successful positioning operation; and/or
to forward the feedback to the TRP to be transmitted to the UE; and/or
to output feedback to the UE so that the UE may enter a sleep phase of a, DRX, cycle.

59. Network entity or LMF according to claim 57, configured to interact with one or more NW entity (e.g. UDM, NEF, GMLC) and exchanging information about the UE (e.g. subscription, provisioning, policy, charging, analytics, expected movement, behavior) and/or information about a RAN-network (e.g. OAM, NG-RAN nodes) so as to determine a configuration to be provided to the UE and its validity area.

60. Network entity or LMF according to claim 57, configured to collect measurements from one or more TRP, and/or to compute position, and/or determine if the position is successful and to send positive feedback to the UE.

61. Network entity, TRP or LMF according to claim 57, configured to receive information from an application function, AF, and/or UE profile and/or UE subscription on a threshold value beyond which the network entity (e.g. LMF/gNB) configures the feedback resource for the UE.

62. Network entity, TRP or LMF according to claim 44, configured to
receive a RA request from the UE wherein the UE requesting to use a particular configuration or requests a NW configuration;
to indicate to a second NW (TRP, gNB) entity to perform measurement and/or to signal a third entity, LMF, to instruct a second NW entity (TRP, gNB) to perform measurement; and/or
to provides or indicate the configuration used by the UE, which may further indicate the expected window where the reference signal is expected;
wherein at least one second NW entity is associated with the validity area of the configuration used by the UE.

63. Communication system comprising the UE according to claim 1 and a TRP Network entity or transmission point, TRP, or another UE comprising a transceiver configured to provide one or more first configurations to an user equipment, the one or more first configurations comprising parameters for a reference signal to be transmitted by the user equipment for position determination; to provide a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from a network entity, and wherein during the sleep phase, the UE is temporarily unreachable (e.g. by paging); so that the user equipment is enabled to transmit the reference signal according to one of the one or more first configuration and taking into account one of the one or more second configurations (defining the DRX cycle); and/or a network entity or LMF configured to perform a measurement or position determination based on an information on a received reference or received signaling message from a UE or based on the reference signal or signaling message received from the UE; wherein the network entity is configured to output a feedback on the reference signal or the signaling message; wherein the feedback indicates one of the following: incorrect or correct receipt of the reference signal and/or the message at a TRP or another UE, e.g. using ACK/NACK; incorrect or correct receipt of the reference signal and/or the message at a TRP or another UE and insufficient or sufficient information to be extracted from the reference signal and/or the message to perform a measurement or position determination; insufficient or sufficient information to be extracted by a LMF from the reference signal and/or the messaging to perform a measurement or position determination; failed or successful measurement or position determination performed by a LMF.

64. Method for operating a UE, comprising the steps:
receiving one or more first configurations from a network entity (e.g. TRP or LMF) of a wireless network, the one or more first configurations comprising parameters for a reference signal to be transmitted by the user equipment for position determination;
receiving a one or more second configurations from the network entity (e.g. gNB), the one or more second configuration comprising parameters describing an active phase and an sleep phase of an UE activity cycle (e.g. DRX cycle or an eDRX cycle), wherein during the active phase the user equipment is configured to receive one or more signaling messages from the network entity, and wherein during the sleep phase, the UE is temporarily unreachable (e.g. by paging);
transmitting the reference signal according to one of the one or more first configuration and taking into account one of the one or more second configurations (defining the DRX cycle).

65. Method for operating a network entity, TRP or another UE, comprising the steps:
communicating with a UE which is configured to transmit a reference signal and/or to signal a message for a measurement during an active phase of a, DRX, cycle;
outputting a configuration including a validity information or a validity information to the UE, wherein the configuration of the UE is valid for a validity area or wherein the UE is allowed to communicate in accordance to the validity information.

66. Method for operating a network entity, TRP or another UE, comprising the steps:
providing one or more first configurations to an user equipment, the one or more first configurations comprising parameters for a reference signal to be transmitted by the user equipment for position determination;
providing a one or more second configurations to an user equipment, the one or more second configuration comprising parameters describing an active phase and an sleep phase of an UE activity cycle (e.g. DRX cycle or an eDRX cycle), wherein during the active phase the user equipment is configured to receive one or more signaling messages from the network entity, and wherein during the sleep phase, the UE is temporarily unreachable (e.g. by paging);
so that the user equipment is enabled to transmit the reference signal according to one of the one or more first configuration and taking into account one of the one or more second configurations (defining the DRX cycle).

67. Method for operating a network entity or LMF, comprising the steps:
performing a measurement or position determination based on an information on a received reference or received signaling message from a UE or based on a reference signal or message received from the UE;
outputting a feedback on the reference signal or the message; wherein the feedback indicates one of the following:
incorrect or correct receipt of a reference signal and/or the message at a TRP or another UE, e.g. using ACK/NACK;
incorrect or correct receipt of the reference signal and/or the message at the TRP or another UE and insufficient or sufficient information to be extracted from the reference signal and/or the message to perform a measurement or position determination;
insufficient or sufficient information to be extracted by the LMF from the reference signal and/or the messaging to perform the measurement or the position determination;
the failed or successful measurement or position determination performed by the LMF.

68. A non-transitory digital storage medium having a computer program stored thereon to perform the method of claim 64 when said computer program is run by a computer.
